(19) United States
(12) Patent Application Publication
(10) Pub. No.: US 2020/0231766 A1
(43) Pub. Date: Jul. 23, 2020

(54) PROCESS FOR THE PRODUCTION OF FIBRE-REINFORCED-COMPOSITES

(71) Applicant: INEOS STYROLUTION GROUP GMBH, Frankfurt am Main (DE)

(72) Inventors: Philipp DEITMERG, Schmallenberg (DE); Eike JAHNKE, Aubonne (CH); Tobias SCHULZ, Koeln (DE); Pierre JUAN, Frankfurt am Main (DE); Norbert NIESSNER, Friedelsheim (DE); Marko BLINZLER, Mannheim (DE)

(21) Appl. No.: 16/648,465

(22) PCT Filed: Sep. 26, 2018
(86) PCT No.: PCT/EP2018/076139

§ 371 Date: Mar. 18, 2020

(30) Foreign Application Priority Data
Sep. 26, 2017 (EP) 17193176.9

(51) Int. Cl. C08J 5/04

(52) U.S. Cl. CPC C08J 5/043; C08J 2325/12

(57) ABSTRACT

The invention relates a process for preparing a fibre-reinforced composite (K) comprising the following steps: (a) Providing at least one continuous fibrous reinforcement material (A); (b) Providing at least one matrix polymer composition (B) having melt volume-flow rate (MVR (220/10) according to ISO 1133) of 40 to 70 mL/10 min and a viscosity number VN (according to DIN 53726) of 45 to 75 ml/g; (c) Applying the at least one matrix polymer composition (B) to at least one surface of the at least one continuous fibrous reinforcement material (A) to obtain a layered arrangement; (d) Heating the layered arrangement obtained in step (c) to a first temperature (T1) sufficiently above the glass transition temperature (Tg) of the at least one substantially amorphous matrix polymer composition (B) to obtain a substantially liquid substantially amorphous matrix polymer composition (B); (e) Allowing the substantially liquid matrix polymer composition (B) to impregnate the at least one continuous fibrous reinforcement material (A); (f) Cooling the thus obtained polymer-impregnated continuous fibrous reinforcement material (A) to a second temperature (T2) below the glass transition temperature (Tg) of the at least one substantially amorphous matrix polymer composition (B) in order to obtain a fibre-reinforced composite (K); wherein substantially amorphous matrix polymer composition (B) is a thermoplastic styrene-based substantially amorphous matrix polymer composition (B) and wherein least one of the process steps (d) and/or (e) is carried out at a temperature in the range of 230 to 330° C.

Fibre-reinforced composite materials consist of a plurality of reinforcing fibres embedded in a polymer matrix. The areas of application of composite materials are diverse. For example, fibre-reinforced composite materials are used in the automotive and aviation industry. Here fibre-reinforced composite materials prevent rupture or other fragmentations of the matrix, thus reducing the risk of accidents by distributed component shreds. Many fibre-reinforced composite materials are able to absorb relatively high forces under load before it comes to a total failure of the material. At the same time the fibre-reinforced composite materials are distinguished compared to conventional, non-reinforced materials by high strength and rigidity combined with low density and other advantageous properties such as good aging and corrosion resistance.

Strength and rigidity of the fibre-reinforced composite materials are adaptable to the load direction and the type of load. Here, the fibres are in the first place responsible for the strength and stiffness of the fibre-reinforced composite material. In addition, their arrangement determines the mechanical properties of the fibre-reinforced composite material. In contrast, the matrix is used primarily for introducing most of the forces to be absorbed into the individual fibres, and for maintaining the spatial arrangement of the fibres in the desired orientation. Since both the fibres and the matrix materials can be varied, numerous combinations of fibres and matrix materials are possible.

In the production of fibre-reinforced composite materials, the well-balanced combination of fibres and matrix plays an essential role. Also, the strength of embedding of the fibres in the polymer matrix (fibre-matrix adhesion) can have a significant influence on the properties of the fibre-reinforced composite material.

For the optimization of the fibre-matrix adhesion and also to compensate the “low chemical similarity” between the fibre surfaces and the surrounding polymer matrix, the reinforcing fibres are pre-treated on a regular basis. For this purpose, so-called sizing agents are regularly added. Such sizing agents are typically applied to the fibres during the preparation to improve the processability of the fibres (such as weaving, sewing). If the sizing agent is undesirable for the subsequent further processing, it must be removed in an additional process step, such as an incineration step. In some cases, fibres are also processed without sizing.

For the manufacture of fibre-reinforced composite material, a further adhesive agent is typically applied in an additional process step. Sizing and/or adhesive agent form a layer on the surface of the fibres which essentially determines the interaction of the fibres with the environment. Today there is a wide variety of adhesive agents available. The skilled person can select a suitable adhesive agent to be used in combination with matrix fibres and a compatible polymer matrix and with the fibres depending on application area.

A technical challenge is that upon the occurrence of total failure the fibre-reinforced composite material may suffer brittle fracture. Thus, for example, in the construction of molded bodies which are subjected to high mechanical stress, a considerable risk of accidents caused by torn components is possible.

Despite these mechanical demands, also aesthetic and economical demands must be met. Since fibre-reinforced composite materials have the potential to find application in various fields, it should be producible with high quality surfaces, without the necessity of further working steps. Moreover, an economically and environmentally friendly production is appreciated.

Therefore, it is desired to provide lightweight fibre-reinforced composite materials, having a wide range of applications, wherein the total failure is unlikely to occur. Desired are also good optical properties such as the ability to manufacture various elements with smooth surfaces from fibre-composite materials.

The fibre-reinforced composite material should be characterized by being easy to process, being largely inert to conventional solvents, having good stress crack resistance, and having a smooth surface. Ideally, the fibre-reinforced composite material does not need an adhesion promoter.

WO 2016/170104 relates to a composite material comprising a) 30 to 95 wt.-% of a thermoplastic material, b) 5 to 70 wt.-% of reinforcement fibres; and c) 0 to 40 wt.-% of further additives. The thermoplastic material is mentioned to have a MVR (220/10) of from 10 to 70 cm³/10 min. The composite material may be thermoformed to a molded body.

It has surprisingly been found by the present inventors that fibre-reinforced composites (K) obtained by a process as described in the following exhibit superior characteristics with respect to surface smoothness and processability. Moreover, the process according to the invention allows a reduction in cycle time compared to the production of conventional fibre-reinforced composites (K).

In a first aspect, the present invention relates to a process for preparing a fibre-reinforced composite (K) comprising at least the following steps:
(a) Providing at least one continuous fibrous reinforcement material (A), preferably at least one laminar structure (S) of the at least one continuous fibrous reinforcement material (A);
(b) Providing at least one substantially amorphous matrix polymer composition (B) having a melt volume-flow rate (MVR (220/10) according to ISO 1133) of 40 to 70 mL/10 min, preferably 45 to 60 mL/10 min and a viscosity number VN (according to DIN 53726) of 45 to 75 ml/g, preferably 55 to 70 ml/g, in particular 60 to 70 ml/g;
(c) Applying the at least one substantially amorphous matrix polymer composition (B) to at least one surface of the at least one continuous fibrous reinforcement material (A) to obtain a layered arrangement;
(d) Heating the layered arrangement obtained in step (c) to a first temperature (T1) sufficiently above the glass transition temperature (Tg) of the at least one substantially amorphous matrix polymer composition (B) to obtain a substantially liquid substantially amorphous matrix polymer composition (B)
(e) Allowing the substantially liquid matrix polymer composition (B) to impregnate the at least one continuous fibrous reinforcement material (A);
(f) Cooling the thus obtained polymer-impregnated continuous fibrous reinforcement material (A) to a second temperature (T2) below the glass transition temperature (Tg) of the at least one substantially amorphous matrix polymer composition (B) in order to obtain a fibre-reinforced composite (K);
   wherein substantially amorphous matrix polymer composition (B) is a thermoplastic styrene-based substantially amorphous matrix polymer composition (B) and wherein least one of the process steps (d) and/or (e) is carried out at a temperature in the range of 230 to 330° C., preferably 250 to 300° C., in particular 270 to 290° C.

It was found that the selection of the specific substantially amorphous, thermoplastic styrene-based matrix polymer composition (B) having a comparatively high melt volume-flow rate provides superior processing properties during the process for preparing a fibre-reinforced composite (K). In particular, a fast and complete impregnation of the at least one continuous fibrous reinforcement material (A) is achieved over a broad temperature range and even at comparatively low temperatures. In this aspect of the invention, it has to be noted that the constituents (A), (B) and (K) may in particular be defined as disclosed in the description of the present invention.

In a further preferred embodiment, the invention relates to a process for preparing a fibre-reinforced composite (K) comprising at least the following steps:
(a) Providing ≥50 wt.-%, based on the total weight of the fibre-reinforced composite (K), of at least one continuous fibrous reinforcement material (A), preferably at least one laminar structure (S) of the at least one continuous fibrous reinforcement material (A);
(b) Providing ≤50 wt.-%, based on the total weight of the fibre-reinforced composite (K), of at least one matrix polymer composition (B) comprising:
   (B1) 60 to 80 wt.-%, preferably 65 to 75 wt.-%, in particular 65 to 70 wt.-%, based on the total weight of the matrix polymer composition (B), of at least one copolymer of styrene and/or α-methyl styrene and acrylonitrile having a number average molecular weight Mn of 30,000 to 100,000 g/mol, preferably 40,000 to 90,000 g/mol; and
   (B2) 20 to 40 wt.-%, preferably 25 to 35 wt.-%, in particular 30 to 35 wt.-%, based on the total weight of the matrix polymer composition (B), of at least one copolymer of styrene, acrylonitrile, maleic anhydride and/or maleic acid and optionally monomers comprising further chemical functional groups which are appropriate to interact with the surface of the at least one continuous fibrous reinforcement material (A) having a number average molecular weight Mn of 30,000 to 100,000 g/mol, preferably 45,000 to 75,000 g/mol;
(c) Applying the at least one matrix polymer composition (B) to at least one surface of the at least one continuous fibrous reinforcement material (A) to obtain a layered arrangement;
(d) Heating the layered arrangement obtained in step (c) to a first temperature (T1) sufficiently above the glass transition temperature (Tg) of the at least one matrix polymer composition (B) to obtain a substantially liquid matrix polymer composition (B);
(e) Allowing the substantially liquid matrix polymer composition (B) to impregnate the at least one continuous fibrous reinforcement material (A);
(f) Cooling the thus obtained polymer-impregnated continuous fibrous reinforcement material (A) to a second temperature (T2) below the glass transition temperature (Tg) of the at least one matrix polymer composition (B) in order to obtain a fibre-reinforced composite (K);
   wherein the at least one matrix polymer composition (B) has a glass transition temperature (Tg) in the range of 100° C. to 150° C., a melt volume-flow rate (MVR (220/10) according to ISO 1133) of 40 to 70 mL/10 min, preferably 45 to 60 mL/10 min and a viscosity number VN (according to DIN 53726) of 45 to 75 ml/g, preferably 55 to 70 ml/g, in particular 60 to 70 ml/g.

It was found that the matrix polymer composition (B), comprising copolymer (B1) and copolymer (B2) is characterized by having preferable processing characteristics combined with an excellent fibre-matrix adhesion. The obtained fibre-reinforced composites (K) are thus superior with respect to mechanical properties as well as surface smoothness.

In a further aspect of the invention, the first temperature (T1) is in the range of 1 to 200° C., preferably 10 to 190° C., above glass transition temperature (Tg) of the at least one substantially amorphous matrix polymer composition (B) and the second temperature (T2) is in the range of 1 to 50° C. below the glass transition temperature (Tg) of the at least one substantially amorphous matrix polymer composition (B). Preferably, the first temperature (T1) is in the range of 180° C. to 300° C., preferably 200° C. to 260° C. In a further preferred embodiment, the second temperature (T2) is in the range of 70° C. to 100° C., preferably 75° C. to 90° C.

In a further aspect of the invention, at least one of the process steps (d) to (f) is carried out under increased pressure, preferably in the range between 1.5 and 3 MPa, in particular between 1.8 and 2.3 MPa. In a particular preferred embodiment of this aspect of the invention, at least the process step (f) is carried out under increased pressure, preferably in the range between 1.5 and 3 MPa, in particular between 1.8 and 2.3 MPa, and the increased pressure is applied in step (f) until the second temperature (T2) is reached.

In a further preferred embodiment, the at least one substantially amorphous matrix polymer composition (B) comprises >0 ands ≤3 wt.-%, preferably ≥0.1 ands ≤2 wt.-%, and in particular ≥0.2 and ≤2 wt.-% of repeating units derived from monomer moieties which are appropriate to interact with the surface of the fibrous reinforcement material (A), in particular of repeating units derived from maleic acid anhydride or maleic acid.

It was found that this amount of maleic acid anhydride was sufficient as a monomer bearing a functional group which is appropriate to interact with the surface of the at least one continuous fibrous reinforcement material (A) to achieve a good fibre-matrix adhesion with having undesired side effects such as decomposition reactions.

In one embodiment of the invention, the at least one continuous fibrous reinforcement material (A) is at least one laminar structure (S) selected from a non-crimp fabric, a woven fabric, a mat, a non-woven fabric or a knitted fabric. In a further preferred embodiment, the fibre-reinforced composite (K) comprises 1 to 12, preferably 2 to 6 laminar structures (S) of the at least one continuous fibrous reinforcement material (A).

In one embodiment of the invention, 1 to 10 laminar structures (S) of a woven or non-crimped fabric and additionally at least one laminar structure (S) of a non-woven fabric are used as the at least one continuous fibrous reinforcement material (A), wherein the at least one laminar structure (S) of a non-woven fabric is positioned on the top and or bottom of the 1 to 10 laminar structures (S) of a woven or non-crimped fabric. This means that a stack of at 1 to 10 laminar structures (S) of a woven or non-crimped fabric and at least one laminar structure (S) of a non-woven fabric is formed, wherein at least one laminar structure (S) of a non-woven fabric forms the first and/or last layer in each stack. In a further preferred embodiment, the least one laminar structure (S) of a non-woven fabric comprises amorphous matrix polymer composition (B) in form of a powder or granules before process step (c) is carried out.

In one aspect of the invention, the at least one fibre reinforcement material (A) constitutes 35 to 55 vol.-% of the entire fibre-reinforced composite (K).

A further object of the invention is the fibre-reinforced composite (K), obtained by the process described herein. A further object is a molded body (M) obtained by thermoforming the fibre-reinforced composite (K). The fibre-reinforced composite (K) and the molded body (M) is preferably used as an element for structural and/or aesthetic applications.

It will be understood that the process for producing a fibre-reinforced composite (K) as described herein comprises one or more other features. The definitions and preferred embodiments are defined in the following.

### Component A

The fibre-reinforced composite (K) comprises at least one continuous fibrous reinforcement material (A). The at least one continuous fibrous reinforcement material (A) may comprise glass fibres and/or carbon fibres. In a preferred embodiment, the at least one continuous fibrous reinforcement material (A) substantially consists of glass fibres and/or carbon fibres. Substantially consisting of glass fibres and/or carbon fibres means that the glass fibres and/or carbon fibres constitute at least 90 wt.-% of the at least one continuous fibrous reinforcement material (A), preferably at least 95 wt.-%, in particular at least 98 wt.-%, based on the entire fibrous material comprised in the at least one continuous fibrous reinforcement material (A). In a further preferred embodiment, the at least one continuous fibrous reinforcement material (A) comprises either glass fibres or carbon fibres. However, it will be understood that the fibre-reinforced composite (K) may comprise a plurality of continuous fibrous reinforcement materials (A), e.g. two or more, each of which may comprise glass fibres and/or carbon fibres, preferably glass fibres or carbon fibres.

In one embodiment of the invention, the at least one continuous fibrous reinforcement material (A) comprises a plurality of at least one chemically functional group on at least a part of at least one surface of the at least one continuous fibrous reinforcement material (A). Appropriate functional groups include, but are not limited to hydroxyl groups, ester groups, and/or amino groups. In a preferred embodiment, the chemical functional groups are appropriate to interact with functional groups present in the least one copolymer (B2). As will be discussed in further detail, the functional groups present in the least one copolymer (B2) originate from the maleic acid anhydride and/or maleic acid moieties (i.e. repeating units derived from the (co)polymerization of maleic acid anhydride monomers and/or maleic acid monomers) and from the optionally monomers comprising further chemical functional groups.

Preferably, the functional groups present at least a part of at least one surface of the at least one continuous fibrous reinforcement material (A) are hydroxyl groups. In a further preferred embodiment, the functional groups comprised in the copolymer (B2) interact with the surface of the continuous fibrous reinforcement material (A) without influencing the polymerization degree of the copolymer (B1). This allows an interaction between the at least one continuous fibrous reinforcement material (A) an the matrix polymer composition (B) without deteriorating the overall melt volume-flow rate and the processability of the fibre-reinforced composite (K).

In one embodiment of the invention, the continuous fibrous reinforcement material (A) of the present invention may optionally comprise a sizing agent applied to at least a part of the surface of the continuous fibrous reinforcement material (A).

Fibres for fibrous reinforcement materials are often treated with a sizing agent, especially to protect the fibres. A mutual damage by abrasion is to be prevented. When mutual mechanical action occurs, cross fragmentation (fracture) of the fibres shall not occur. Further, the fibres may be facilitated by means of the sizing of the cutting process to obtain mainly a same stack length. In addition, agglomeration of the fibres can be avoided by the sizing. The dispersibility of short fibres in water can be improved. Thus, it is possible to obtain uniform sheet after wet-laying process. A sizing may contribute to an improved cohesion between the glass fibres and the polymer matrix in which the fibres serve as reinforcing fibres. This principle is particularly used for glass fibre reinforced plastic (GFRP) applications. Typically, sizing agents generally contain a large number of ingredients such as film forming agents, lubricants, wetting agents and adhesive agents.

A film forming agent protects the fibres from mutual friction and can also enhance the affinity to synthetic resins to thereby promote the strength and adhesion of a composite material. Starch derivatives, polymers and copolymers of vinyl acetate and acrylic esters, epoxy resin emulsions, polyurethane resins and polyamides with a proportion of 0.5 to 12 wt.-%, based on the total amount of sizing, are to be mentioned.

A lubricant gives the fibres and their products suppleness and reduces the mutual friction of the glass fibres. Often, however, the adhesion between glass fibres and synthetic resins is impaired by the use of lubricants. Fats, oils and polyalkylene amines in an amount of 0.01 to 1 wt.-%, based on the total amount of sizing, are to be mentioned.

Wetting agents cause a reduction of the surface tension and improved wetting of the filaments having the size. For aqueous finishing, for example poly fatty acid amides with an amount of 0.1 to 1 to 5 wt.-%, based on the total amount of sizing, are to be mentioned.

Often there is no suitable affinity between the polymer matrix and the fibres. This may be overcome by means of adhesive agents, which increase the adhesion of polymers on the fibre surface. Typically organo-functionalized silanes such as aminopropyl triethoxysilane, methacryloxypropyl trimethoxysliane, glycidyloxypropyl trimethoxysilan and the like are used.

In an alternative, preferred embodiment of the invention, the continuous fibrous reinforcement material (A) of the present invention is (substantially) free of a sizing agent, i.e. comprises less than 3 wt.-%, preferably less than 1 wt.-% and in particular less than 0.1 wt.-% of sizing agents, based on the entire weight of the continuous fibrous reinforcement material (A). If the continuous fibrous reinforcement material (A) of the present invention comprises a sizing agent applied to at least a part of the surface of the continuous fibrous reinforcement material (A), the sizing agent may by removed from the surface prior to the application in accordance with the present invention. This may for example be achieved by thermal desizing processes (e.g. incineration).

In a preferred embodiment, the continuous fibrous reinforcement material (A) comprises fibres having a fibre diameter substantially in the range of from 5 to 20 μm, preferably 8 to 16 μm. Preferably, at least 80 wt.-%, more preferably at least 90 wt.-% and in particular at least 95 wt.-% of the fibres enclosed in the continuous fibrous reinforcement material (A) are fibres having a fibre diameter in the specified range.

In a preferred embodiment, the fibrous continuous reinforcement material (A) substantially consists of fibres having a fibre diameter in the range of from 5 to 20 μm, preferably 8 to 16 μm.

The at least one continuous fibrous reinforcement material (A) preferably comprises the fibres in form of a yarn having a linear mass density of from 100 to 5000 tex, wherein linear mass density is determined according to ISO 1144 or DIN 60905 and 1 tex equates to 1 g per 1000 m of fibre.

In one embodiment, the at least one continuous fibrous reinforcement material (A) preferably comprises the fibres in form of a yarn having a linear mass density of from 1000 to 5000, preferably 1000 to 4000 tex, more preferred 2000 to 4000 and in particular 2500 to 3500 tex. Preferably, in this embodiment the yarn is (substantially) made from carbon fibres.

In an alternative embodiment, the at least one continuous fibrous reinforcement material (A) preferably comprises the fibres in form of a yarn having a linear mass density of from 100 to 2000 tex, preferably 150 to 1500 tex, in particular 190 to 1250 tex. Preferably, in this embodiment the yarn is (substantially) made from glass fibres.

The continuous fibrous reinforcement material (A) is composed of fibres comprising preferably no short fibres (“chopped fibres”) and the fibre-reinforced composite (K) is not a short fibre reinforced material. At least 50 wt.-%, preferably at least 75 wt.-%, in particular at least 85 wt.-% of the fibres of the continuous fibrous reinforcement material (A) have preferably a length of at least 5 mm, more preferably at least 10 mm or more than 100 mm.

The continuous fibrous reinforcement material (A) is preferably present as laminar structure (S). The skilled person is aware that laminar structures (S) of fibrous materials differ from short fibres, at least by forming contiguous, larger structures, which in general will be longer than 5 mm. In this case the laminar structures (S) are preferably present in substantially the entire fibre-reinforced composite (K). This means that the laminar structure (S) spreads over more than 50%, preferably at least 70%, especially at least 90% of the length of the fibre-reinforced composite (K). The length here is the largest expansion in one of the three spatial directions. More preferably, the laminar structure (S) spreads over more than 50%, preferably at least 70%, especially at least 90% of the area of the fibre-reinforced composite (K). The area herein is the area of the largest expansion in two of the three spatial directions. The continuous fibre-reinforced composite (K) is preferably a (substantially) flat continuous fibre-reinforced composite (K).

The at least one continuous fibrous reinforcement material (A) is preferably present in form of a laminar structure, in particular in form of a non-crimp fabric, a woven fabric, a mat, a non-woven fabric or a knitted fabric.

In a non-crimp fabric, the fibres are ideally parallel front and stretched. Continuous fibres are mostly used. Weavings are formed by the interweaving of endless fibres, such as rovings. The weaving of fibres is necessarily accompanied by an undulation of the fibres. The undulation causes a lowering in particular the fibre-parallel compressive strength. Mats usually consist of short and long fibres which are loosely connected to each other via a binder. Non-wovens are structures of limited length fibres, continuous fibres (filaments) or cut yarns of any sort and any origin, which have been joined together in some manner to form a web and bonded together in some way. Knits (knitted fabrics) are thread systems by intermeshing.

In one embodiment, at least one laminar structure (S) of the at least one continuous fibrous reinforcement material (A) is present as a woven fabric. In a preferred embodiment, the at least one laminar structure (S) of the at least one continuous fibrous reinforcement material (A) is selected from a twill weave, a satin weave or a plain weave, and is, in particular, a twill weave.

In plain weave, the warp and weft are aligned so they form a simple criss-cross pattern. Each weft thread crosses the warp threads by going over one, then under the next, and so on. The next weft thread goes under the warp threads that its neighbor went over, and vice versa.

The satin weave is characterized by four or more fill or weft yarns floating over a warp yarn or vice versa, four warp yarns floating over a single weft yarn.

In a twill weave, each weft or filling yarn floats across the warp yarns in a progression of interlacings to the right or left, forming a pattern of distinct diagonal lines. This diagonal pattern is also known as a wale. A float is the portion of a yarn that crosses over two or more perpendicular yarns.

A twill weave requires three or more harnesses, depending on its complexity. Twill weave is often designated as a fraction, such as 2/1, in which the numerator indicates the number of harnesses that are raised (and thus threads crossed: in this example, two), and the denominator indicates the number of harnesses that are lowered when a filling yarn is inserted (in this example, one).

In a particular preferred aspect of the invention, the at least one laminar structure (S) of the at least one continuous fibrous reinforcement material (A) is a 2/2 twill weave.

In one alternative embodiment, at least one laminar structure (S) of the at least one continuous fibrous reinforcement material (A) is present as non-crimp fabric, in particular a multi-axial non-crimp fabric.

Non-crimp fabrics are typically composed of two or more plies, or layers of unidirectional fibres. Each individual layer can be oriented in a different axis and for this reason the fabric construction or assembly is referred to as multi-axial. Depending on the number of layers and varying orientation and axis, unidirectional, bi-axial, tri-axial and quadri-axial architecture can be assembled into one non-crimp fabric system.

In a preferred embodiment, of the invention, the at least one laminar structure (S) of the at least one continuous fibrous reinforcement material (A) is present as bi-axial non-crimp fabric, in particular a bi-axial non-crimp fabric having a 0°/90° or +45°/−45° orientation. In a 0°/90° orientation, layers having a 0° and 90° orientation with respect to the longitudinal extension of the crimp fabric alternate. In a +45°/−45° orientation, the alternating layers have a +45° or −45° orientation with respect to the longitudinal extension of the crimp fabric instead.

The weight rate within the woven or non-crimp fabric may be balanced or non-balanced. This means that the amount of fibres (as measured in wt.-% of the entire at least one continuous fibrous reinforcement material (A)) in one direction (e.g. warp or weft in a weave as well as each bi-axial layer in a non-crimp fabric) may account to the total area weight in different rates. This may, for example be achieved, by using yarns having different linear mass densities for each of these directions (e.g. warp yarn and weft yarn, or the yarns for each of the orientation layers of the non-crimp fabric).

In one preferred embodiment, the at least one continuous fibrous reinforcement material (A) has a balanced weight rate, i.e. a weight rate of 50 wt.-% to 50 wt.-%. In particular, a balanced weight rate is preferred in woven fabrics, such as twill weaves, as well as non-crimp fabrics.

In an alternative embodiment, the at least one continuous fibrous reinforcement material (A) has a non-balanced weight rate, preferably a weight rate of 60 to 40 wt-% to 90 to 10 wt.-%, for example a weight rate of 80 to 20 wt.-%. In particular, a non-balanced weight rate is preferred in bi-axial non-crimp fabrics. In a preferred embodiment, a bi-axial non-crimp fabric having a 0°/90° has a 0° orientation layer with a balance of 60 to 90 wt.-%, for example 80 wt.-%, and a 90° orientation layer with a weight rate of 10 to 40 wt.-%, for example 20 wt.-%.

In one embodiment, at least one laminar structure (S) of the at least one continuous fibrous reinforcement material (A) is present as non-woven fabric, in particular a non-woven fabric having an area weight of 10 to 200 g/m², preferably 20 to 100 g/m², and in particular of 30 to 80 g/m².

In a preferred embodiment, the at least one laminar structure (S) of the at least one continuous fibrous reinforcement material (A) has an area weight of 10 to 1000 g/m².

In one embodiment of the invention, the at least one laminar structure (S) of the at least one continuous fibrous reinforcement material (A) preferably has an area weight of 50 to 1000 g/m², preferably 100 to 500 g/m², in particular 150 to 300 g/m². Most preferably, the laminar structure (S) has an area weight of 150 to 250 g/m². In a preferred embodiment, the at least one laminar structure (S) of the at least one continuous fibrous reinforcement material (A) having an area weight in this range is (substantially) made from carbon fibres. Preferably, the at least one laminar structure (S) of the at least one continuous fibrous reinforcement material (A) having an area weight in this range is prepared as a twill weave, in particular as a 2/2 twill weave.

In an alternative embodiment of the invention, the at least one laminar structure (S) of the at least one continuous fibrous reinforcement material (A) preferably has an area weight of 50 to 1000 g/m², preferably 200 to 750 g/m², in particular 250 to 650 g/m². In a preferred embodiment, the at least one laminar structure (S) of the at least one continuous fibrous reinforcement material (A) having an area weight in this range is (substantially) made from glass fibres. Preferably, the at least one laminar structure (S) of the at least one continuous fibrous reinforcement material (A) having an area weight in this range is prepared as a twill weave, in particular as a 2/2 twill weave, or a non-crimp fabric, in particular having a biaxial orientation.

In a further alternative embodiment of the invention, the at least one laminar structure (S) of the at least one continuous fibrous reinforcement material (A) preferably has an area weight of 10 to 200 g/m², preferably 20 to 100 g/m², and in particular of 30 to 80 g/m². In a preferred embodiment, the at least one laminar structure (S) of the at least one continuous fibrous reinforcement material (A) having an area weight in this range is (substantially) made from glass fibres. Preferably, the at least one laminar structure (S) of the at least one continuous fibrous reinforcement material (A) having an area weight in this range is prepared as a mat.

As previously pointed out, the fibre-reinforced composite (K) comprises at least one continuous fibrous reinforcement material (A), but, however, may comprise a plurality of laminar structures (S) of at least one continuous fibrous reinforcement material (A). It will be understood that each of these laminar structures (S) of at least one continuous fibrous reinforcement material (A) may be the same or different with respect to the comprised fibre (e.g. material, thickness, pre-treatment) or the composition of the laminar structure (S) (e.g. with respect to the form (non-crimp fabric, woven fabric, mat, non-woven fabric or knitted fabric) and/or area weight).

In one embodiment of the invention, each laminar structure (S) of the at least one continuous fibrous reinforcement material (A) has a thickness of 0.1 to 0.5 mm, preferably 0.1 to 0.2 mm, and the fibre-reinforced composite (K) comprises at least one laminar structure (S) of the at least one continuous fibrous reinforcement material (A).

As previously pointed out, the fibre-reinforced composite (K) comprises at least one continuous fibrous reinforcement material (A), in particular at least one laminar structure (S) of the at least one continuous fibrous reinforcement material (A). It will be understood, that the invention is not limited to this structure. Thus, in a preferred embodinvent, the fibre-reinforced composite (K) comprises a plurality of the at least one continuous fibrous reinforcement materials (A), in particular a plurality of laminar structures (S) of the at least one continuous fibrous reinforcement material (A), wherein each of the continuous fibrous reinforcement materials (A) and/or laminar structures (S) may be the same or different. This will be explained in more detail below.

### Component (B)

The fibre-reinforced composite (K) comprises at least one substantially amorphous, thermoplastic styrene based matrix polymer composition (B) having a melt volume-flow rate (MVR (220/10) according to ISO 1133) of 40 to 70 mL/10 min, more preferably 45 to 60 mL/10 min, and a viscosity number VN (determined in dimethylformamide (DMF) according to DIN 53726) of 45 to 75 ml/g, preferably 55 to 70 ml/g, in particular 60 to 70 ml/g.

It was found by the inventors that the specific combination of melt volume-flow rate and viscosity number allows the preparation of a fibre-reinforced composite (K) using the matrix polymer composition (B) over a broad temperature range and even at comparatively low temperatures.

The matrix polymer composition (B) is substantially amorphous, wherein amorphous means that the macromolecules are arranged completely randomly without regular arrangement and orientation, i.e. without constant distance. Preferably, the matrix polymer composition (B) is amorphous, exhibits thermoplastic properties and is therefore meltable and (substantially) non-crystalline.

As a result, the shrinkage of the matrix polymer composition (B), and hence of the entire fibre-reinforced composite (K), is comparatively low. It was found that fibre-reinforced composites (K) may be obtained which exhibit superior properties with respect to producability, processability as well as product properties, in particular toughness, stiffness and surface quality.

The at least one substantially amorphous matrix polymer composition (B) preferably has a mold shrinkage according to ISO 294-4 of less than 1%, preferably in the range of 0.1 to 0.9, in particular in the range of 0.2 to 0.8%.

Preferably, the matrix polymer composition (B) comprises:
(B1) 60 to 80 wt.-%, preferably 65 to 75 wt.-%, in particular 65 to 70 wt.-%, based on the total weight of the matrix polymer composition (B), of at least one copolymer of styrene and/or α-methyl styrene and acrylonitrile having a number average molecular weight Mn of 30,000 to 100,000 g/mol, preferably 40,000 to 90,000 g/mol; and
(B2) 20 to 40 wt.-%, preferably 25 to 35 wt.-%, more preferred 25 to 35 wt.-%, and in particular 30 to 35 wt.-%, based on the total weight of the matrix polymer composition (B), of at least one copolymer of styrene, acrylonitrile, maleic acid anhydride and/or maleic acid and optionally monomers comprising further chemical functional groups which are appropriate to interact with the surface of the at least one continuous fibrous reinforcement material (A) having a number average molecular weight Mn of 30,000 to 100,000 g/mol, preferably 45,000 to 75,000 g/mol.

The at least one substantially amorphous matrix polymer composition (B) preferably comprises >0 and ≤3 wt.-%, preferably ≥0.1 and ≤2 wt.-%, and in particular ≥0.2 ands ≤2 wt.-% of repeating units derived from maleic acid anhydride or maleic acid. Additionally, further repeating units derived from monomer moieties may be comprised which are appropriate to interact with the surface of the continuous fibrous reinforcement material (A). In a particular preferred embodiment, the at least one substantially amorphous matrix polymer composition (B) comprises ≥0.2 and ≤0.9 wt.-%, preferably ≥0.25 and ≤0.40 wt.-%, in particular ≥0.30 and ≤0.35 wt.-% repeating units derived from maleic acid anhydride or maleic acid. In a further preferred embodiment, the at least one substantially amorphous matrix polymer composition (B) comprises no other repeating units derived from monomer moieties which are appropriate to interact with the surface of the continuous fibrous reinforcement material (A) than repeating units derived from maleic acid anhydride or maleic acid.

It was surprisingly found by the inventors that an amorphous matrix polymer composition (B) comprising the above defined blend of copolymer (B1) and copolymer (B2), wherein the amorphous matrix polymer composition (B) comprises a comparatively low amount of repeating units derived from monomer moieties which are appropriate to interact with the surface of the continuous fibrous reinforcement material (A), in particular of repeating units derived from maleic acid anhydride or maleic acid, exhibits a unique and advantageous combination of properties, in particular with respect to the melt volume-flow rate (MVR) which results in a good interpenetration of the continuous fibrous reinforcement material (A) and with respect to interaction between the amorphous matrix polymer composition (B) and the continuous fibrous reinforcement material (A) (fibre-matrix adhesion), resulting in superior mechanical properties.

Moreover, the reduction of repeating units derived from maleic acid anhydride or maleic acid in the matrix polymer composition (B) has the advantage, that less functional groups which are prone to undergo undesired side reactions, in particular decomposition reactions, are present in the fibre-reinforced composite (K). It was observed that repeating units derived from maleic acid anhydride or maleic acid may, under certain conditions, in particular at temperatures above 200° C., decompose under formation of a gaseous product, presumably CO₂. This gas formation may result in gas enclosures in the fibre-reinforced composite (K) which then may deteriorate the mechanical properties of the fibre-reinforced composite (K). By reducing the amount of repeating units derived from maleic acid anhydride or maleic acid in the matrix polymer composition (B), it is possible to provide a fibre-reinforced composite (K) which is substantially free of gas inclusions and voids. The mechanical properties of the fibre-reinforced composite (K) may therefore be improved. Moreover, reducing the amount of repeating units derived from maleic acid anhydride or maleic acid has also economic advantages since maleic acid anhydride or maleic acid are more expensive and more elaborative to be produced compared to styrene and acrylonitrile.

The at least one substantially amorphous matrix polymer composition (B) preferably has a glass transition temperature of at least 100° C. In a preferred embodiment, the glass transition temperature of the at least one substantially amorphous matrix polymer composition (B) is ≤150° C.

The at least one substantially amorphous copolymer (B) preferably has a density in the range of from 1 to 1.2 g/cm³, preferably in the range from 1.05 to 1.10 g/cm³ (determined according to ISO 1183).

The at least one substantially amorphous matrix polymer composition (B) preferably has a Vicat softening temperature (VST/B/50 according to ISO 306) of 90 to 130° C., in particular 95 to 120° C.

In one embodiment of the invention, the at least one substantially amorphous matrix polymer composition (B) preferably comprises at least one copolymer (B1) and at least one copolymer (B2) wherein the copolymer (B1) has a number-average molecular weight and/or weight-average molecular weight distribution which is different from the number-average molecular weight and/or weight-average molecular weight distribution, respectively, of the copolymer (B2). According to this aspect of the invention, the at least one substantially amorphous matrix polymer composition (B) exhibits a bimodal molecular weight distribution.

The at least one substantially amorphous matrix polymer composition (B) may preferably be obtained by blending at least one copolymer (B1), at least one copolymer (B2) and optionally at least one additive (C) in the amounts specified herein. It will be understood that a plurality of different copolymers (B1), different copolymers (B2) and/or optionally different additives (C) may be combined to obtain the at least one substantially amorphous matrix polymer composition (B), as long as the sum of each of those compounds does not exceed the predetermined amounts of the compounds as defined herein.

In a preferred embodiment of the invention, after the preparation according to methods known the skilled person the matrix polymer composition (B) is prepared and preferably processed to granules. Thereafter, the preparation of the fibre-reinforced composite (K) can take place.

### Copolymer (B1)

The substantially amorphous matrix polymer composition (B) preferably comprises 60 to 80 wt.-%, preferably 65 to 75 wt.-%, in particular 65 to 70 wt.-%, based on the total weight of the matrix polymer composition (B), of at least one copolymer of styrene and/or α-methyl styrene and acrylonitrile, in particular at least one styrene-acrylonitrile copolymer and/or at least one α-methyl styrene-acrylonitrile copolymer. Preferably, the at least one copolymer (B1) is a substantially amorphous copolymer of styrene or amethyl styrene and acrylonitrile.

Copolymer (B1) is preferably selected from the group consisting of: styrene-acrylonitrile copolymers (SAN), α-methylstyrene-acrylonitrile copolymers (AMSAN), impact-modified acrylonitrile-styrene copolymers, in particular acrylonitrile-butadiene-styrene copolymers (ABS), and acrylonitrile-styrene-acrylic ester copolymers (ASA). However, in a preferred embodiment, the copolymer (B1) is not an impact-modified copolymer.

Preferably, the at least one copolymer (B1) is selected from at least one substantially amorphous styrene-acrylonitrile copolymer (SAN) and/or at least one amorphous amethylstyrene-acrylonitrile copolymer (AMSAN), in particular at least one amorphous styrene-acrylonitrile copolymer (SAN).

In general, any SAN and/or AMSAN copolymer known in in the art may be used within the subject-matter of the present invention. In a preferred embodiment, the SAN and AMSAN copolymers of the present invention contain:
from 50 to 99 wt.-%, based on the total weight of the SAN and/or AMSAN copolymer, of at least one member selected from the group consisting of styrene and α-methyl styrene, and
from 1 to 50 wt.-%, based on the total weight of the SAN and/or AMSAN copolymer, of acrylonitrile.

Particularly preferred ratios by weight of the components making up the SAN or AMSAN copolymer are 60 to 95 wt.-%, based on the total weight of the SAN and/or AMSAN copolymer, of styrene and/or α-methyl styrene and 40 to 5 wt.-%, based on the total weight of the SAN and/or AMSAN copolymer, of acrylonitrile.

Particularly preferred are SAN or AMSAN copolymers containing proportions of incorporated acrylonitrile monomer units of <36 wt.-%, based on the total weight of the SAN and/or AMSAN copolymer.

More preferred are copolymers of styrene with acrylonitrile of the SAN or AMSAN type incorporating comparatively little acrylonitrile (not more than 35 wt.-%, based on the total weight of the SAN and/or AMSAN copolymer).

Most preferred are copolymers as component made from, based on
from 65 to 81 wt.-%, preferably 70 to 80 wt.-% based on the total weight of the SAN and/or AMSAN copolymer, of at least one member selected from the group consisting of styrene and α-methyl styrene, and
from 19 to 35 wt.-%, preferably 20 to 30 wt.-% based on the total weight of the SAN and/or AMSAN copolymer, of acrylonitrile.

In one embodiment, the at least one copolymer (B1) is an AMSAN copolymer.

In an alternative, particular preferred embodiment, the at least one copolymer (B1) is a SAN copolymer.

In a preferred embodiment of the invention, the copolymer (B1) is a copolymer obtained from copolymerizing a monomer mixture comprising
≥74 to ≤78 wt.-%, preferably ≥75 to ≤77 wt.-%, based on the total weight of the SAN copolymer, of styrene, and
≥22 to ≤26 wt.-%, preferably ≥23 to ≤25 wt.-%, based on the total weight of the SAN copolymer, of acrylonitrile.

The at least one copolymer (B1) preferably has a number average molecular weight Mn of 30,000 to 100,000 g/mol, preferably 40,000 to 90,000 g/mol, and in particular 50,000 to 80,000 g/mol. The weight average molecular weight Mw is typically in the range of 55,000 to 250,000 g/mol, preferably 80,000 to 225,000 g/mol and in particular 90,000 to 200,000 g/mol. In a particular preferred embodiment, the at least one copolymer (B1) preferably has a number average molecular weight Mn of 55,000 to 75,000 g/mol and a weight average molecular weight Mw in the range of 125,000 to 185,000 g/mol. Typically, the molecular weight is determined by gel permeation chromatography (GPC) using tetrahydrofuran (THF) as solvent and combined RI/UV detectors. Calibration is made using anionically polymerized, monodisperse polystyrene calibration standards.

The polydispersity index (PDI) of the copolymer (B1) is typically in the range of from 1.5 to 3, preferably from 1.7 to 2.7, in particular from 1.9 to 2.6. The PDI is calculated as PDI=Mw/Mn.

The at least one copolymer (B1) preferably has a viscosity number VN (determined according to DIN 53726 in DMF) of from 45 to 75 ml/g, preferably 55 to 70 ml/g, in particular 60 to 70 ml/g are in particular preferred.

The least one copolymer (B1) preferably has a density of less than 1.2 g/cm³, preferably in the range from 1 to 1.19 g/cm³ (determined according to ISO 1183).

The at least one copolymer (B1) preferably has melt volume-flow rate (MVR (220/10)) of 10 to 90 mL/10 min, preferably 30 to 80 mL/10 min, more preferably 50 to 80 mL/10 min, and in particular 56 to 80 mL/10 min. In one embodiment, the (MVR (220/10)) of the at least one copolymer (B1) is in the range of 60 to 80 ml/10 min, preferably 60 to 70 ml/10 min, often from 63 to 66 ml/10 min (determined according to ISO1133).

The at least one copolymer (B1) preferably has a mold shrinkage according to ISO 294-4 of less than 1.5%, preferably less than 1%, more preferably in the range of 0.1 to 0.9, in particular in the range of 0.2 to 0.8%.

Preferably, the at least one copolymer (B1) is a (substantially) amorphous, (substantially) non-crystalline, thermoplastic polymer.

The at least one copolymer (B1) preferably has a Vicat softening temperature (VST/B/50 according to ISO 306) of 90 to 130° C., in particular 95 to 120° C.

SAN and AMSAN copolymers are known and the methods for their preparation, for instance, by radical polymerization, more particularly by emulsion, suspension, solution and bulk polymerization, are also well documented in the literature. Preferably, a solution polymerization process is adapted, e.g. as described in the patent application GB 1 472 195 A.

### Component (B2)

The at least one substantially amorphous matrix polymer composition (B) further preferably comprises 20 to 40 wt.-%, preferably 25 to 35 wt.-%, in particular 30 to 35 wt. %, based on the total weight of the matrix polymer composition (B), of at least one copolymer (B2) of styrene, acrylonitrile, maleic acid anhydride and/or maleic acid and optionally monomers comprising further chemical functional groups which are appropriate to interact with the surface of the continuous fibrous reinforcement material (A). In particular, chemically reactive functional groups comprised in the maleic acid anhydride, maleic acid or the optionally monomers comprising further chemical functional groups are able to react during the manufacturing process of the continuous fibre-reinforced composite (K) with chemical groups located at least on a part of the surface of the fibrous reinforcing material (A).

Thus, the copolymer (B2) imparts functional groups to the matrix polymer composition (B) which allow the copolymer (B2) to act as a compatibilizer between the copolymer (B1) and the continuous fibrous reinforcing material (A). This is achieved by an interaction between the functional groups of the copolymer (B2) and the functional groups present on at least a part of the surface of the at least one continuous fibrous reinforcing material (A). Due to its similar chemical properties, the copolymers (B1) and (B2) are highly compatible and the compatibilization between the copolymer (B1) and the at least one continuous fibrous reinforcing material (A) is achieved.

It will be understood that the polar functional groups comprised in the copolymer (B2) preferably interact with the surface of the continuous fibrous reinforcement material (A) without influencing the polymerization degree of the copolymer (B1), thus leaving the overall melt volume-flow rate of the copolymer (B1) unchanged.

Suitable monomers bearing functional groups include, besides maleic acid anhydride and/or malic acid, monomers capable of undergoing the formation of bonds, in particular covalent bonds, with the functional groups of the fibrous material (A) such as hydroxyl groups, ester groups, and/or amino groups. Preferred monomers are those which are able to react with hydroxyl or amino groups and form covalent bonds.

According to one embodiment, the monomers are selected from the group consisting of N-phenylmaleimid (PM), tert-butyl (meth) acrylate and glycidyl (meth) acrylate (GM). According to a preferred embodiment the monomers are selected from the group consisting of N-phenylmaleimide (PM) and glycidyl (meth) acrylate (GM).

However, according to one particular preferred embodiment, copolymer (B2) comprises only functional groups which are appropriate to interact with the surface of the continuous fibrous reinforcement material (A) and which are derived from maleic acid anhydride and/or maleic acid.

Thus, in a further preferred embodiment, the at least one copolymer (B2) is obtained by the copolymerization of styrene, acrylonitrile, maleic acid anhydride and/or maleic acid, in particular by the copolymerization of styrene, acrylonitrile, and maleic acid anhydride.

A preferred copolymer (B2) is prepared by copolymerizing a monomer composition having the following composition:
(b2-i) 60 to 90 wt.-% of styrene;
(b2-ii) 9.9 to 39.9 wt.-% of acrylonitrile; and
(b2-iii) 0.1 to 10 wt.-% of maleic acid anhydride;
   wherein (b2-i), (b2-ii) and (b2-iii) sum up to 100 wt.-%.

In a further preferred embodiment, the at least one copolymer (B2) is obtained by co-polymerizing a monomer mixture having the following composition:
(b2-i) 70 to 80 wt.-% styrene;
(b2-ii) 19.9 to 29.9 wt.-% acrylonitrile; and
(b2-iii) 0.1 to 5 wt.-% maleic acid anhydride;
   wherein (b2-i), (b2-ii) and (b2-iii) sum up to 100 wt.-%.

In a further preferred embodiment, the at least one copolymer (B2) is obtained by co-polymerizing a monomer mixture having the following composition:
(b2-i) 74 to 76 wt.-% styrene;
(b2-ii) 21 to 25.5 wt.-% acrylonitrile; and
(b2-iii) 0.5 to 3 wt.-% maleic acid anhydride;
   wherein (b2-i), (b2-ii) and (b2-iii) sum up to 100 wt.-%.

In one preferred embodiment of the invention, the at least one copolymer (B2) is obtained by co-polymerizing a monomer mixture comprising 0.75 to 2.5 wt.-% maleic acid anhydride, based on the entire weight of the copolymer of styrene, acrylonitrile and maleic acid anhydride.

In one preferred embodiment of the invention, the at least one copolymer (B2) is obtained by co-polymerizing a monomer mixture comprising 0.75 to 1.25 wt.-% maleic acid anhydride, based on the entire weight of the copolymer of styrene, acrylonitrile and maleic acid anhydride.

In an alternative preferred embodiment of the invention, the at least one copolymer (B2) is obtained by co-polymerizing a monomer mixture comprising 2.0 to 2.2 wt.-% maleic acid anhydride, based on the entire weight of the copolymer of styrene, acrylonitrile and maleic acid anhydride.

The least one copolymer (B2) preferably has a number average molecular weight Mn of 30,000 to 100,000 g/mol, preferably 40,000 to 90,000 g/mol, and in particular 45,000 to 75,000 g/mol. The weight average molecular weight Mw is typically in the range of 55,000 to 250,000 g/mol, preferably 80,000 to 225,000 g/mol and in particular 90,000 to 200,000 g/mol. In a particular preferred embodiment, the at least one copolymer (B2) preferably has a number average molecular weight Mn of 45,000 to 65,000 g/mol and a weight average molecular weight Mw in the range of 105,000 to 165,000 g/mol. Typically, the molecular weight is determined by gel permeation chromatography (GPC) using tetrahydrofuran (THF) as solvent and combined RI/UV detectors. Calibration is made using anionically polymerized, monodisperse polystyrene calibration standards.

The polydispersity index (PDI) of the copolymer (B2) is typically in the range of from 1.5 to 3, preferably from 1.7 to 2.7, in particular from 1.9 to 2.6. The PDI is calculated as PDI=Mw/Mn.

The at least one copolymer (B2) preferably has a mold shrinkage according to ISO 294-4 of less than 1.5%, preferably less than 1%, more preferably in the range of 0.1 to 0.9, in particular in the range of 0.2 to 0.8%.

Preferably, the at least one copolymer (B2) is a (substantially) amorphous, (substantially) non-crystalline, thermoplastic polymer.

The copolymer (B2) preferably has a Vicat softening temperature (VST/B/50 according to ISO 306) of 95 to 120° C., in particular 100 to 110° C.

The least one substantially amorphous copolymer (B2) preferably has a density in the range of from 1 to 1.2 g/cm³, preferably in the range from 1.05 to 1.10 g/cm³ (determined according to ISO 1183).

The at least one copolymer (B2) preferably has melt volume-flow rate (MVR (220/10)) of 10 to 60 mL/10 min, preferably 15 to 40 mL/10 min, and in particular 20 to 30 mL/10 min (determined according to ISO1133).

Preferably, the at least one copolymer (B2) has a viscosity number (VN) of 75 to 90 ml/g, in particular 77 to 85 ml/g.

Copolymers (B2) generally are known in the art and the methods for their preparation, for instance, by radical polymerization, more particularly by emulsion, suspension, solution and bulk polymerization, are also well documented in the literature. Preferably, a solution polymerization process is adapted, e.g. as described in the patent application GB 1 472 195 A.

### Component C

As a further component (C) the fibre-reinforced composite (K) may optionally contain 0 to 40 wt.-%, preferably 0 to 30 wt.-%, particularly preferably 0 to 10 wt.-%, based on the total weight of components (A) to (C), of one or more additives different from the components (A) and (B) (auxiliaries and additives). In a preferred embodiment, the fibre-reinforced composite (K) comprises no additives (C) which are gaseous at temperatures below 350° C., in particular below 300° C. This reduces the release and loss of these additives during the process for producing the fibre-reinforced composite (K) and/or a molded body (M).

In one embodiment of the invention, the fibre-reinforced composite (K) comprises substantially no additives (C), i.e. not more than 1 wt.-%, preferably not more than 0.5 wt.-%, based on the total weight of components (A) to (C). If, however, additives (C) are present, the optional additives (C) are preferably admixed with the matrix polymer composition (B) prior to the preparation of the fibre-reinforced composite (K).

Particulate mineral fillers, processing aids, stabilizers, oxidation retardants, agents against thermal decomposition and decomposition by ultraviolet light, lubricating and demolding agents, flame retardants, dyes and pigments and plasticizers are to be mentioned as optional additive (C). Also, esters as low molecular weight compounds may be mentioned. According to the present invention, two or more of these compounds can be used. In general, the compounds are having a molecular weight less than 3000 g/mol, preferably less than 150 g/mol.

Particulate mineral fillers may, for example, be made available in form of amorphous silica, carbonates such as magnesium carbonate, calcium carbonate (chalk), powdered quartz, mica, variety of silicates such as clays, muscovite, biotite, suzorite, tin maletit, talc, chlorite, phlogopite, feldspar, calcium silicates such as wollastonite or kaolin, particularly calcined kaolin.

UV-stabilizers include, for example, various substituted resorcinols, salicylates, benzotriazoles and benzophenones, which are generally used in amounts of up to 2 wt.-%, based on the entire matrix polymer composition (B) are to be mentioned.

According to the invention, the thermoplastic molding composition the matrix polymer composition (B) may comprise antioxidants and heat stabilizers. Sterically hindered phenols, hydroquinone, substituted representatives of this group, secondary aromatic amines, optionally in conjunction with phosphorus-containing acids or salts thereof, and mixtures of these compounds, preferably in concentrations up to 1 wt.-%, based on the weight of the matrix polymer composition (B), can be used.

Further additives according to the invention include lubricants and release agents, which are usually added in amounts up to 1 wt.-% of the matrix polymer composition (B). Stearyl alcohols, alkyl stearates and amides, preferably Irganox®, as well as esters of pentaerythritol with long-chain fatty acids are to be mentioned here. Also calcium, zinc or aluminum salts of stearic acid and dialkyl ketones, for example distearyl ketone, may be used. Further, ethylene oxide-propylene oxide copolymers may be used as lubricants and release agents. Furthermore, natural and synthetic waxes can be used. These include PP waxes, PE waxes, PA waxes, PO grafted waxes, HDPE waxes, PTFE waxes, EBS waxes, montane wax, carnauba waxes and beeswaxes.

Flame retardants can be both halogen-containing and halogen-free compounds. Suitable halogen-containing compounds remain stable in the manufacture and processing of the fibre-reinforced composite (K) and/or the matrix polymer composition (B) of the invention so that no corrosive gases are released and the effectiveness is not impaired. Brominated compounds are preferable over the respective chlorinated compounds. Halogen-free compounds such as phosphorus compounds, in particular phosphine oxides and derivatives of acids of phosphorus and salts of acids and acid derivatives of phosphorus are preferably used. Particularly preferred phosphorus compounds comprise ester, alkyl, cycloalkyl and/or aryl groups.

Further suitable additives are oligomeric phosphorus compounds having a molecular weight of less than 2000 g/mol, such as, for example, in EP-A 0 363 608 are described.

Also pigments and dyes may be included. These are generally present in amounts from 0 to 15, preferably 0.1 to 10 and in particular 0.5 to 8 wt.-%, based on the total weight of components (B) to (C) included. Pigments for coloring thermoplastics are commonly known, see for example R. Gächter and H. Muller, Taschenbuch der Kunststoffadditive, Carl Hanser Verlag, 1983, pages 494 to 510.

A first preferred group of pigments to be mentioned are white pigments such as zinc oxide, zinc sulfide, white lead (PbCO₃)₂.Pb(OH)₂), lithopone, antimony trioxide and titanium dioxide. Of the two most common crystal polymorphs (rutile and anatase) of titanium dioxide, the rutile form is preferably used for white coloring of the molding compositions according to the invention.

Black pigments which can be used according to the invention are iron oxide black (Fe₃O₄), spinel black (Cu(Cr,Fe)₂O₄), manganese black (mixture of manganese dioxide, silicon oxide and iron oxide), cobalt black and antimony black and particularly preferably carbon black, usually in the form of furnace black is used (see G. Benzing, Pigmente für Anstrichmittel, Expert-Verlag (1988), pp 78ff).

Of course, certain hues may be adjusted using inorganic color pigments such as chromium oxide green or organic color pigments such as azo pigments and phthalocyanines. Such pigments are generally commercially available.

Furthermore, it may be advantageous to use the above-mentioned pigments or dyes in a mixture, for example carbon black with copper phthalocyanines, since the color is facilitated in the polymers.

### Fibre-Reinforced Composite (K)

The fibre-reinforced composite (K) according to the present invention comprises at least one continuous fibrous reinforcement material (A) and least one substantially amorphous matrix polymer composition (B), wherein the at least one continuous fibrous reinforcement material (A) and the least one substantially amorphous matrix polymer composition (B) are as defined above. In particular, the fibre-reinforced composite (K) according to the present invention preferably comprises ≥50 wt.-%, based on the total weight of the fibre-reinforced composite (K), of at least one continuous fibrous reinforcement material, and <50 wt.-%, based on the total weight of the fibre-reinforced composite (K), of at least one substantially amorphous matrix polymer composition (B).

It was surprisingly found by the present inventors, that the specific composition of the substantially amorphous matrix polymer composition (B) allows the preparation of a fibre-reinforced composite (K) having a high amount of at least one continuous fibrous reinforcement material (A), while the processability of the fibre-reinforced composite (K) is improved, in particular with respect to thermoforming processes. At the same time, the surface-properties of the fibre-reinforced composite (K) are improved compared to known composite materials, whereas the good mechanical properties are substantially unaffected.

In one embodiment of the invention, the fibre-reinforced composite (K) may advantageously comprise ≥50 wt.-% to ≤80 wt.-% of the at least one continuous fibrous reinforcement material (A), based on the total weight of the fibre-reinforced composite (K). In one further embodiment, the fibre-reinforced composite (K) comprises ≥50 wt.-% to ≤60 wt.-% of the at least one continuous fibrous reinforcement material (A), based on the total weight of the fibre-reinforced composite (K), for example 51 wt.-% to 59 wt.-%. In an alternative embodiment, the fibre-reinforced composite (K) comprises ≥60 wt.-% to ≤70 wt.-% of the at least one continuous fibrous reinforcement material (A), based on the total weight of the fibre-reinforced composite (K), for example 61 wt.-% to 69 wt.-%.

Thus, in one embodiment of the invention, the fibre-reinforced composite (K) may advantageously comprise >20 wt.-% to <50 wt.-% of the at least one substantially amorphous matrix polymer composition (B), based on the total weight of the fibre-reinforced composite (K). In one further embodiment, the fibre-reinforced composite (K) may comprise >40 wt.-% to <50 wt.-% of the at least one substantially amorphous matrix polymer composition (B), based on the total weight of the fibre-reinforced composite (K). In an alternative embodiment, the fibre-reinforced composite (K) may comprise >30 wt.-% to <40 wt.-% of the at least one substantially amorphous matrix polymer composition (B), based on the total weight of the fibre-reinforced composite (K).

In a further embodiment of the invention, the at least one continuous fibrous reinforcement material (A) preferably constitutes 35 to 55 vol.-%, preferably 40 to 50 vol.-% and in particular 45 to 47 vol.-%, of the entire fibre-reinforced composite (K) based on the volume of the fibre-reinforced composite (K).

The at least one continuous fibrous reinforcement material (A) may be embedded in any orientation and location in the fibre-reinforced composite (K) and is preferably entirely enclosed by the at least one substantially amorphous matrix polymer composition (B). This means that the outer surface of the entire fibre-reinforced composite (K) is preferably formed by the at least one substantially amorphous matrix polymer composition (B).

The continuous fibrous reinforcement material (A) is preferably not statistically uniformly distributed in the fibre-reinforced composite (K), but in laminar structures (S) having higher or lower percentages of fibres (therefore as more or less separate layers). Thus, the fibre-reinforced composite (K) contain laminar structures (S) of substantially flat layers of the at least one continuous fibrous reinforcement material (A) and layers of the substantially amorphous matrix polymer composition (B) containing the at least one copolymer (B1) and the at least one copolymer (B2), as well as optionally additive (C). However, it is understood that the substantially amorphous matrix polymer composition (B) also interpenetrates the substantially flat layers of the at least one continuous fibrous reinforcement material (A).

As previously pointed out, in one embodiment of the invention, the fibre-reinforced composite (K) comprises at least one laminar structure (S) of continuous fibrous reinforcement material (A). In a further preferred embodiment, the fibre-reinforced composite (K) may preferably comprise a plurality of continuous fibrous reinforcement materials (A), in particular a plurality of laminar structures (S) (i.e. a plurality of layers) of the at least one continuous fibrous reinforcement material (A). Each of the laminar structures (S) (or layers) may be the same or different. It is to be understood that the different layers may in particular vary in view of the yarn (in particular with respect to fibre diameter and/or linear mass density), the form of the continuous fibrous reinforcement material (A) (e.g. non-crimp, woven, mat, non-woven, etc.) and the specific area weight. The laminar structures (S) are stacked within the fibre-reinforced composite (K). In a preferred embodiment, each of the laminar structures (S) embedded in the same orientation and location in the fibre-reinforced composite (K). In an alternative preferred embodiment each of the laminar structures (S) is embedded in the same location but in an orientation rotated by 90° compared to the adjacent laminar structures (S) in the fibre-reinforced composite (K). By each of these stacking sequences, preferred laminates are formed.

In a further preferred embodiment, the fibre-reinforced composite (K) comprises 1 to 12, preferably 2 to 6 laminar structures (S) (or layers) of a continuous fibrous reinforcement material (A). Each laminar structure (S) (or layer) of continuous fibrous reinforcement material (A) may be the same or different. It is to be understood that the laminar structures (S) (or layers) may in particular vary in view of the yarn (in particular with respect to fibre diameter and/or linear mass density), the form of the continuous fibrous reinforcement material (A) (e.g. non-crimp or woven, mat, non-woven, etc.) and the specific area weight.

In one aspect of the invention, the fibre-reinforced composite (K) comprises 1 to 10, preferably 2 to 6, in particular 4 laminar structures (S) (or layers) of a woven or non-crimped fabric as continuous fibrous reinforcement material (A). Each layer of continuous fibrous reinforcement material (A) in this aspect of the invention may be the same or different, and is preferably the same.

In an further embodiment of this aspect of the invention, the laminate comprising 1 to 10, preferably 2 to 6, in particular 4 laminar structures (S) (or layers) of a woven or non-crimped fabric as continuous fibrous reinforcement material (A), additionally comprises at least one laminar structure (S) of a non-woven fabric on the upper and lower side of the laminate. This means that the first and the final laminar structure (S) within each stack or stacking sequence of the fibre-reinforced composite (K) is a non-woven fabric. It was found by the inventors, that a non-woven fabrics as final laminar structure (S) on each side of the laminate further improves the surface properties of the fibre-reinforced composite (K) with respect to optical appearance and smoothness.

In a preferred embodiment, at least 50%, preferably at least 65%, in particular at least 80%, of the number of laminar structures (S) in the fibre-reinforced composite (K) are woven or non-crimp fabrics, and up to 50%, preferably up to 35%, in particular up to 20%, of the number of laminar structures (S) may be non-woven fabrics.

The fibre-reinforced composite (K) may be shaped to molded bodies (M) in a thermoforming process. As will be discussed in detail, the fibre-reinforced composite (K) has a comparatively broad temperature range in which it can be formed to molded bodies (M) in a thermoforming process. In particular the temperature range, in which the thermoforming process may be carried out extents over a range of 150° C. below the temperature necessary for softening the fibre-reinforced composite (K). According to a further aspect of the invention, the fibre-reinforced composite (K), may be molded in a thermoforming process subjected at temperatures of at least 160° C., preferably 150° C., in particular 140° C.

Process for the preparation of the fibre-reinforced composite (K)

The fibre-reinforced composite (K) is obtained by a process comprising at least the following steps:
(a) Providing at least one continuous fibrous reinforcement material (A), preferably at least one laminar structure (S) of the at least one continuous fibrous reinforcement material (A);
(b) Providing at least one substantially amorphous matrix polymer composition (B) having a melt volume-flow rate (MVR (220/10) according to ISO 1133) of 40 to 70 mL/10 min, preferably 45 to 60 mL/10 min and a viscosity number VN (according to DIN 53726) of 45 to 75 ml/g, preferably 55 to 70 ml/g, in particular 60 to 70 ml/g;
(c) Applying the at least one substantially amorphous matrix polymer composition (B) to at least one surface of the at least one continuous fibrous reinforcement material (A) to obtain a layered arrangement;
(d) Heating the layered arrangement obtained in step (c) to a first temperature (T1) sufficiently above the glass transition temperature (Tg) of the at least one substantially amorphous matrix polymer composition (B) to obtain a substantially liquid substantially amorphous matrix polymer composition (B)
(e) Allowing the substantially liquid matrix polymer composition (B) to impregnate the at least one continuous fibrous reinforcement material (A);
(f) Cooling the thus obtained polymer-impregnated continuous fibrous reinforcement material (A) to a second temperature (T2) below the glass transition temperature (Tg) of the at least one substantially amorphous matrix polymer composition (B) in order to obtain a fibre-reinforced composite (K);
   wherein substantially amorphous matrix polymer composition (B) is a thermoplastic styrene-based substantially amorphous matrix polymer composition (B) and wherein least one of the process steps (d) and/or (e) is carried out at a temperature in the range of 230 to 330° C., preferably 250 to 300° C., in particular 270 to 290° C.

It was found that the described temperature range is particularly suited to achieve a complete impregnation of the at least one continuous fibrous reinforcement material (A) with the substantially amorphous matrix polymer composition (B). This allows a fast process cycle and results in high quality surfaces of the fibre-reinforced composite if a thermoplastic styrene-based polymer having a melt volume-flow rate (MVR (220/10) according to ISO 1133) of 40 to 70 mL/10 min, preferably 45 to 60 mL/10 min and a viscosity number VN (according to DIN 53726) of 45 to 75 ml/g, preferably 55 to 70 ml/g, in particular 60 to 70 ml/g, is selected as matrix polymer composition (B).

More particular, the fibre-reinforced composite (K) is preferably prepared by a process comprising at least the following steps:
(a) Providing ≥50 wt.-%, based on the total weight of the fibre-reinforced composite (K), of at least one continuous fibrous reinforcement material (A), preferably at least one laminar structure (S) of the at least one continuous fibrous reinforcement material (A);
(b) Providing <50 wt.-%, based on the total weight of the fibre-reinforced composite (K), of at least one matrix polymer composition (B) comprising:
   (B1) 60 to 80 wt.-%, preferably 65 to 75 wt.-%, in particular 65 to 70 wt.-%, based on the total weight of the matrix polymer composition (B), of at least one copolymer of styrene and/or α-methyl styrene and acrylonitrile having a number average molecular weight Mn of 30,000 to 100,000 g/mol, preferably 40,000 to 90,000 g/mol; and
   (B2) 20 to 40 wt.-%, preferably 25 to 35 wt.-%, in particular 30 to 35 wt.-%, based on the total weight of the matrix polymer composition (B), of at least one copolymer of styrene, acrylonitrile, maleic anhydride and/or maleic acid and optionally monomers comprising further chemical functional groups which are appropriate to interact with the surface of the at least one continuous fibrous reinforcement material (A) having a number average molecular weight Mn of 30,000 to 100,000 g/mol, preferably 45,000 to 75,000 g/mol;
(c) Applying the at least one matrix polymer composition (B) to at least one surface of the at least one continuous fibrous reinforcement material (A) to obtain a layered arrangement;
(d) Heating the layered arrangement obtained in step (c) to a first temperature (T1) sufficiently above the glass transition temperature (Tg) of the at least one matrix polymer composition (B) to obtain a substantially liquid matrix polymer composition (B);
(e) Allowing the substantially liquid matrix polymer composition (B) to impregnate the at least one continuous fibrous reinforcement material (A);
(f) Cooling the thus obtained polymer-impregnated continuous fibrous reinforcement material (A) to a second temperature (T2) below the glass transition temperature (Tg) of the at least one matrix polymer composition (B) in order to obtain a fibre-reinforced composite (K);
   wherein the at least one matrix polymer composition (B) has a glass transition temperature (Tg) in the range of 100° C. to 150° C., a melt volume-flow rate (MVR (220/10) according to ISO 1133) of 40 to 70 mL/10 min, preferably 45 to 60 mL/10 min and a viscosity number VN (according to DIN 53726) of 45 to 75 ml/g, preferably 55 to 70 ml/g, in particular 60 to 70 ml/g.

As regards the at least one continuous fibrous reinforcement material (A) and the at least one substantially amorphous matrix polymer composition (B), the above definitions apply. In particular, the at least one substantially amorphous matrix polymer composition (B) comprises at least one copolymer (B1) and at least one copolymer (B2).

In one embodiment of the invention, the fibre-reinforced composite (K) may further comprise at least one additive (C). Although this may, in general, be added in any of the process steps, the at least one additive (C)—if present—is preferably admixed with the at least one substantially amorphous matrix polymer composition (B) prior to the provision of the at least one substantially amorphous matrix polymer composition (B) in process step (b). The preparation of blends of thermoplastic polymers and additives is known in the art. Any known process may be applied. For example, the optional additive (C) may be added during or after the polymerization process of either of the copolymers (B1) and/or (B2). Alternatively, the optional additive (C) may be added during the blending process of the copolymers (B1) and/or (B2) in order to obtain the at least one substantially amorphous matrix polymer composition (B). Alternatively, the optional additive (C) may be blended with the at least one substantially amorphous matrix polymer composition (B) in a separate process step.

The at least one substantially amorphous matrix polymer composition (B) may be provided in any known form, e.g. in form of granules, powders, foils, melts. In a preferred embodiment, the at least one substantially amorphous matrix polymer composition (B) is provided to the process in form of a substantially liquid melt. The substantially liquid melt may, for example, be prepared in in the optionally heatable mixing devices, such as discontinuously operating, heated internal kneading devices with or without RAM, continuously operating kneaders, such as continuous internal kneaders, screw kneaders with axially oscillating screws, Banbury kneaders, furthermore extruders, and also roll mills, mixing roll mills with heated rollers, and calenders. In a preferred embodiment, these mixing apparatuses may also be applied for the blending of the constituents (B1), (B2) and optionally (C) in order to obtain the at least one substantially amorphous matrix polymer composition (B).

“Substantially liquid” or “substantially liquid melt” means that the at least one substantially amorphous matrix polymer composition (B), as well as the predominant liquid-melt (softened) fraction, may further comprise a certain fraction of solid constituents, examples being unmelted fillers and reinforcing material such as glass fibres, metal flakes, or else unmelted pigments, colorants, etc. “Liquid melt” means that the polymer mixture is at least of low fluidity, therefore having softened at least to an extent that it has plastic properties.

The at least one substantially amorphous matrix polymer composition (B) is applied to at least one surface of the at least one continuous fibrous reinforcement material (A) to obtain a layered arrangement. In one embodiment, the at least one substantially amorphous matrix polymer composition (B) may be applied to more than one surface of the at least one continuous fibrous reinforcement material (A) to obtain a layered arrangement, in particular to at least two surfaces, preferably two opposing surfaces.

In a preferred embodiment, the first temperature (T1) is in the range of 1 to 200° C., preferably 10 to 190° C., above glass transition temperature (Tg) of the at least one substantially amorphous matrix polymer composition (B) and the second temperature (T2) is in the range of 1 to 50° C. below the glass transition temperature (Tg) of the at least one substantially amorphous matrix polymer composition (B). Preferably, the first temperature (T1) is in the range of 180° C. to 300° C., preferably 200° C. to 260° C. In a further preferred embodiment, the second temperature (T2) is in the range of 70° C. to 100° C., preferably 75° C. to 90° C.

It was found that the described temperature range for the first temperature (T1) is particularly suited to achieve a complete impregnation of the at least one continuous fibrous reinforcement material (A) with the substantially amorphous matrix polymer composition (B). Also, a preferably complete interaction between the at least one continuous fibrous reinforcement material (A) and the copolymer (B2) occurs at these conditions quickly. Moreover, the solidification below the second temperature (T2) allows a good control of the shape and the surface properties of the fibre-reinforced composite (K).

In one embodiment of the process for preparing a fibre-reinforced composite (K) at least one of the process steps (d) to (f) is carried out under increased pressure, preferably in the range between 1.5 and 3 MPa, in particular between 1.8 and 2.3 MPa. Preferably, at least the process step (f) is carried out under increased pressure, preferably in the range between 1.5 and 3 MPa, in particular between 1.8 and 2.3 MPa, and the increased pressure is applied in step (f) until the second temperature (T2) is reached.

In one embodiment of the invention, the fibre-reinforced composite (K) is prepared from a plurality of continuous fibrous reinforcement materials (A), in particular from a plurality of laminar structures (S) of the at least one continuous fibrous reinforcement material (A), preferably 1 to 12, and in particular 2 to 6, e.g. 3, 4 or 5. In this embodiment, the at least one substantially amorphous matrix polymer composition (B) may be provided to each of the laminar structures (S) of the at least one continuous fibrous reinforcement material (A) separately. However, in a preferred embodiment, the at least one substantially amorphous matrix polymer composition (B) is provided in form of a substantially liquid melt in a central layered position of the stack or stacking sequence of laminar structures (S). It was found that the substantially liquid melt of the at least one substantially amorphous matrix polymer composition (B) is appropriate to impregnate the entire laminar structure (S) under the conditions of the preparation process, due to the comparably high melt volume-flow rate of the matrix polymer composition (B).

However, in order to further improve the surface smoothness of the fibre-reinforced composite (K), further amounts of the amorphous matrix polymer composition (B) may be applied to the outer surfaces of the upper and lower (first and last) laminar structure (S) of the at least one continuous fibrous reinforcement material (A) in each stack or stacking sequence. In one particular preferred embodiment, these upper and lower (first and last) laminar structure (S) in each stack or stacking sequence are non-woven fabrics, in particular glass fibre non-woven fabrics. Preferably, the non-woven fabrics are provided with an additional amount of the amorphous matrix polymer composition (B) in form of a powder or in form of granule which are substantially uniformly distributed at least on the outermost surface of the non-woven fabric. In one embodiment of this aspect of the invention, 70 to 90 wt.-% of the entire amorphous matrix polymer composition (B) is provided to the center of the stack/laminate of laminar structures (S) of the at least one continuous fibrous reinforcement material (A), preferably in form of a substantially liquid melt, and 5 to 30 wt.-% of the entire amorphous matrix polymer composition (B) is provided to the upper and lower (first and last) laminar structure (S) of the at least one continuous fibrous reinforcement material (A) in each stack or stacking sequence, preferably in form of a powder or in form of granules.

In one embodiment of the invention, 1 to 10 laminar structures (S) of a woven or non-crimped fabric and additionally at least one laminar structure (S) of a non-woven fabric are used as the at least one continuous fibrous reinforcement material (A), wherein the at least one laminar structure (S) of a non-woven fabric is positioned on the top and or bottom of the 1 to 10 laminar structures (S) of a woven or non-crimped fabric. This means that a stack of at 1 to 10 laminar structures (S) of a woven or non-crimped fabric and at least one laminar structure (S) of a non-woven fabric is formed, wherein at least one laminar structure (S) of a non-woven fabric forms the first and/or last layer in each stack. In a further preferred embodiment, the least one laminar structure (S) of a non-woven fabric comprises amorphous matrix polymer composition (B) in form of a powder or granules before process step (c) is carried out.

In one aspect of this embodiment, the laminate comprising 1 to 10, preferably 2 to 6, in particular 4 laminar structures (S) (or layers) of a woven or non-crimped fabric as continuous fibrous reinforcement material (A), additionally comprises at least one laminar structure (S) of a non-woven fabric on the upper and lower side of the laminate. This means that the first and the final laminar structure (S) within each stack or stacking sequence of the fibre-reinforced composite (K) is a non-woven fabric. It was found by the inventors, that a non-woven fabrics as final laminar structure (S) on each side of the laminate further improves the surface properties of the fibre-reinforced composite (K) with respect to optical appearance and smoothness.

The process may preferably comprise a further consolidation step, wherein gas enclosures in the fibre-reinforced composite (K) are reduced and a good bond is made between the at least one continuous reinforcement material (A) and the at least one amorphous matrix polymer composition (B). Preferably, a (substantially) pore-free fibre-reinforced composite (K) is obtained after impregnation and consolidation.

In an alternative embodiment, the described process steps may be performed in a separate sequence. For example, firstly laminar structures (S) of the at least one continuous reinforcement material (A) may be prepared, whereby an impregnation of the reinforcement material (A) with the at least one matrix polymer composition (B) takes place. Subsequently, a predetermined number of impregnated laminar structures (S) of the at least one continuous reinforcement material (A) may be combined in form of stacks/laminates and may then consolidated in a further process step to form the fibre-reinforced composite (K).

Before the reinforcement material (A) is impregnated with the matrix polymer composition (B), at least a portion of the reinforcement material (A) may be subjected to a pre-treatment in order to influence, preferably improve, the later fibre-matrix adhesion. The pretreatment may, for example, include a coating step, an etching step, a heat treatment step or a mechanical surface treatment step. In particular, for example, by heating a part of the reinforcement material (A), an already applied adhesion promoter and/or sizing agent can be at least partially removed.

The fibre-reinforced composite (K) according to the invention may be used as obtained in the described process. However, in an alternative embodiment, the fibre-reinforced composite (K) may be further processed, in particular in a thermoforming process to prepare a molded body (M).

### Process for the Preparation of a Molded Body (M)

The fibre-reinforced composite (K) described herein may in particular be used as starting material for the shaping of a molded body (M) in a thermoforming process. In particular, three-dimensional molded bodies (M) are preferably prepared from the fibre-reinforced composites (K) by the process described in the in following. However, the shaping of the molded body (M) may also include the shaping of a substantially two-dimensional body, wherein additional material is applied to at least one surface of the fibre-reinforce composite (K). Alternatively, the thermoforming process may also be applied to further improve the surface properties of the fibre-reinforced composite (K).

The process for thermoforming a fibre-reinforced composite (K) to a molded body (M) preferably comprises at least the following steps:
(i) Providing a fibre-reinforced composite (K) as described herein;
(ii) Heating the fibre-reinforced composite (K) to a temperature (T3) at which the at least one substantially amorphous matrix polymer composition (B) is substantially softened;
(iii) Thermoforming the fibre-reinforced composition (K) in a mold at a mold surface temperature (T4) in order to obtain a molded body (M);
(iv) Releasing the molded body (M) from the mold;
   wherein the mold surface temperature (T4) is ≥50° C.

The fibre-reinforced composite (K) in step (i) is preferably provided by a process in accordance with the above-described process.

In process step (ii), the fibre-reinforced composite (K) is then heated to a temperature (T3). This step may be accomplished by any be accomplished by any heating device known in the art which is suitable for the heating of fibre-reinforced materials. Suitable heating devices employ for example infra-red radiation, hot air or hot surfaces of molding devices, wherein the surface is preferably heated by a heat transfer medium such as oil within the molding device or by an inductive heating device. In a preferred embodiment, infra-red radiation is used as a heating device. In an alternative embodiment, a hot surface of molding device is used. The surface may, in particular be heated by an inductive heating device.

The temperature (T3) is a temperature, at which the at least one substantially amorphous matrix polymer composition (B) is substantially softened, and is in particular liquid. The fibre-reinforced composite (K) may thus be formed to the desired shape of the molded body (M). Preferably, the temperature (T3) is below the decomposition temperature of the at least one substantially amorphous matrix polymer composition (B), preferably below 300° C. This reduces the decomposition of the matrix polymer composition (B) and the release of decomposition products. In a particular preferred embodiment, the temperature (T3) in process step (ii) is in the range of ≥200° C. and ≤280° C., in particular in the range of ≥220° C. and ≤250° C. This ensures that the temperature of the fibre-reinforced composite (K) is sufficiently high for the thermoforming process step (iii) even if the heated fibre-reinforced composite (K) has to be transferred from the heating device used in process step (ii) to the molding device used in process step (iii).

The thermoforming step (iii) of the process for producing a molded body (M) may be carried out in any device known in the art as long as the above defined temperature regimes are observed. Preferably, the thermoforming step (iii) is carried out under increased pressure in order to obtain a molded body (M) which is precisely shaped. In particular, the pressure applied is ≥0.1 MPa, more preferably ≥0.3 MPa. In one embodiment the pressure applied is ≤10 MPa, in particular ≤5 MPa. In a particular preferred embodiment of the invention, the pressure applied is within the range of ≥0.5 MPa and ≤2.0 MPa. It is particular preferable that the fibre-reinforced composite (K) heated in step (ii) has a temperature of at least 170° C. to 180° C. prior to entering step (iii).

The mold surface temperature (T4) designates the temperature of the surface of the mold which contacts the surface of the fibre-reinforced composite (K) while the fibre-reinforced composite (K) is formed to the shape of the molded body (M). The mold surface temperature (T4) is ≥50° C. in order to allow the shaping of the fibre-reinforced composite (K).

In one embodiment of the invention, the mold surface temperature (T4) is within the range of ≥50° C. and ≤90° C., preferably within the range of ≥60° C. and ≤80° C. This allows the shaping a molded body (M) which may be released from the mold without the necessity of further cooling. Since the mold surface temperature (T4) is below the glass transition temperature (Tg) of the at least one substantially amorphous matrix polymer composition (B) in this case, the molded body (M) is sufficiently solid immediately after the thermoforming process. Process step (iv) is then accordingly accomplished by opening the mold or molding device.

However, in a preferred embodiment of the invention, the mold surface temperature (T4) is above the glass transition temperature (Tg) of the at least one substantially amorphous matrix polymer composition (B), preferably 10 to 50° C., in particular 20 to 40° C., above the glass transition temperature (Tg) of the at least one substantially amorphous matrix polymer composition (B). In a preferred embodiment, the mold surface temperature (T4) is within the range of ≥130° C. and ≤210° C., preferably within the range of ≥140° C. and ≤200° C. In a further preferred embodiment, the mold surface temperature (T4) is in the range of 140° C. to 170° C., preferably 140 to 160° C. It was found by the present inventors, that a mold surface temperature within this range allows the thermoforming of the fibre-reinforced composite (K) to a molded body (M) which exhibits an extraordinary smooth surface.

If the mold surface temperature (T4) is above the glass transition temperature (Tg), at least the surface of the molded body (M) has to be cooled and sufficiently solidified prior to the release of the molded body (M) from the mold. In particular, the surface of the molded body (M) has to be cooled to a temperature below the glass transition temperature (Tg) of the at least one substantially amorphous matrix polymer composition (B), preferably at least 5° C., in particular at least 15° C. below the glass transition temperature (Tg) of the at least one substantially amorphous matrix polymer composition (B). In a preferred embodiment, this is achieved by a process (in the following also called variotherm process) comprising the following process steps:
(i) Providing a fibre-reinforced composite (K) as described herein;
(ii) Heating the fibre-reinforced composite (K) to a temperature (T3) at which the at least one substantially amorphous matrix polymer composition (B) is substantially softened;
(iii) (a) Thermoforming the fibre-reinforced composition (K) in a mold at a first mold surface temperature (T4) in order to obtain a molded body (M);
   (b) Reducing the temperature of the mold surface to a second mold surface temperature (T5) below the glass transition temperature (Tg) of the least one substantially amorphous matrix polymer composition (B) in order to solidify at least the surface of the molded body (M);
(iv) Releasing the molded body (M) from the mold;
   wherein the first mold surface temperature (T4) is at least 10 to 50° C., in particular at least 20 to 40° C., above the glass transition temperature (Tg) of the at least one substantially amorphous polymer composition (B) and the second mold surface temperature (T5) is at least 5° C., in particular at least 15° C., below the glass transition temperature (Tg) of the at least one substantially amorphous polymer composition (B).

This process is called a variotherm process. Variotherm processes are characterized by having control on the temperature of the thermoforming process at each point of the process. This is achieved by using devices, in particular molding devices, which allow to control and adjust the surface temperature of the device (or mold) by active heating and/or cooling of the mold surface. This may be achieved by heat transfer media, e.g. water or oil, which circulate within the device, i.e. in direct contact to the surface of the device, in particular in direct contact with the surface of the mold.

In a preferred embodiment, the thermoforming process is carried out in a molding device which allows a variotherm processing using an inductive heating device. Due to the short heating phases of the inductive heating device, a remarkable shorting of the required cycle time is achieved. By using the variotherm process, further improvements of the surface of the molded body (M) may be achieved. By rapidly cooling the mold after the thermoforming is completed, at least the surface of the molded body (M) may be cooled to temperatures below the glass transition temperature (Tg) of the matrix polymer composition (B) within the mold. Since the glass transition temperature (Tg) of the matrix polymer composition (B) is comparatively low, and furthermore substantially no crystallization occurs in the substantially amorphous matrix polymer composition (B), only little shrinkage will occur to the molded body (M) after being released from the process device. This further improves the smoothness of the surface of the molded body (M).

By applying a process device using inductive heating, the heating and cooling rates may be further accelerated, thus increasing the described effects and advantages. Cooling is preferably achieved by an internal cooling circuit comprising water, glycols and/or oils.

It was found that the variotherm process allows a fast process cycle and results in high quality surfaces of the fibre-reinforced composite if a thermoplastic styrene-based polymer having melt volume-flow rate (MVR (220/10) according to ISO 1133) of 40 to 70 mL/10 min and a viscosity number of 45 to 75 ml/g is selected as matrix polymer composition (B).

In one embodiment of the invention, at least one of the process steps (i), (ii) and/or (iii) is carried out in a device which allows a variotherm processing, in particular a variotherm processing using inductive heating. This allows as fast temperature change of the fibre-reinforced composite (K) and/or the molded body (M) which is accompanied by a short cycle time and a high surface quality of the molded body (M), i.e. a low waviness of the molded body (M).

Moreover, from the above it is evident that the temperature range in which the thermoforming process may be carried out is within the range of (T3)<300° C. and (T4) ≥50° C., in particular in the range from ≤280° C. to ≥130° C. The temperature range at which the fibre-reinforced composite (K) has sufficient moldability therefore ranges over 150° C., preferably over 250° C. Such a broad processing temperature range is unknown for conventional fibre-reinforced materials and provides more flexibility in the molding process.

Moreover, due to the unique combination of high amount of continuous fibrous reinforcement material (A), high specific melt volume-flow rate (MVR) and molecular weight of the substantially amorphous matrix polymer composition (B), as well as high fibre-matrix adhesion due to the bonds formed between the continuous fibrous reinforcement material (A) and the copolymer (B2), the reinforced composite (K) exhibits unique processing properties: during the inventive process for preparing a molded body (M) as described herein, substantially no decomposition, degassing and/or dripping of the substantially amorphous matrix polymer composition (M) occurs.

In a preferred embodiment, the at last one substantially amorphous matrix polymer composition (B) has a mold shrinkage according to ISO 294-4 of less than 1.5%, preferably less than 1%, more preferably in the range of 0.1 to 0.9, in particular in the range of 0.2 to 0.8%. This further results in molded bodies (M) having a high surface quality, in particular having a low waviness of the surface. In a particular preferred embodiment of this aspect of the invention, a molded body (M) is obtained, wherein the wherein the surface of the molded body (M) possesses a waviness characterized by Δw defined as the average altitude difference between a wave trough and a wave peak of less than 10 μm, preferably less than 8 μm.

In a further aspect of the invention, the process for thermoforming a fibre-reinforced composite (K) to a molded body (M) may include further process steps, in particular process steps which are appropriate to apply a coating and/or a print to at least one surface of the molded body (M).

In one embodiment of this aspect of the invention, the process further comprises a process step, wherein a film (F), in particular a decoration film, is applied to at least one surface of the fibre-reinforced composite (K) prior to the thermoforming step (iii). The film (F) is preferably a polymer film comprising at least one styrene-containing copolymer, in particular at least one acrylonitrile-butadiene-styrene copolymer (ABS copolymer).

The film (F) preferably has a décor which is suited to provide a desired surface appearance or design to the molded body (M).

In an alternative embodiment, the film (F) may also be applied to the surface of the molded body (M) after process step (iii) has been carried out. In this aspect of the invention, however, an additional process step is required, wherein the film (F) is applied to at least one surface of the molded body (M). The thus obtained laminate is heated to a temperature which allows the formation of an adhesion between the film (F) and the molded body (M), preferably a temperature between the above-defined temperatures (T3) and (T4). Optionally, in a preferred embodiment, pressure is applied to at least a part of the surface of the thus obtained laminate. In particular, the pressure applied is at least ≥0.1 MPa, more preferably ≥0.3 MPa. In one embodiment the pressure applied is ≤10 MPa, in particular ≤5 MPa. In a particular preferred embodiment, the pressure applied is within the range of ≥0.5 MPa and ≤2.0 MPa. This process step is in particular recommended, if the film (F) is sensitive (e.g. very thin), or if the shape of the molded body (M) is very complex and a destruction of the film (F) is likely to occur during the shaping of the molded body (M) if the film is applied prior to the thermoforming step (iii).

In a further aspect of the invention, the process may further comprise a process step, wherein the molded body (M) is further processed by applying a coating and/or a print on at least one surface of the molded body (M). Compared to conventional thermoplastic fibre-reinforced materials, the fibre-reinforced composite (K) as well as the molded body (M) comprises surfaces which have a comparatively high polarity and are therefore suited to be coated with coating or printing materials such as paints or inks. The coating or print shows excellent adhesion to the surface of the fibre-reinforced composite (K) or the molded body (M).

In a further aspect of the invention, the process for producing a molded body (M) from a fibre-reinforced composite (K) is employed for producing a molded body (M) having a carbon-fibre look, i.e. having an optical appearance, wherein the fibrous material embedded within the molded body (M) is visible over at least a part of the surface of the molded body (M). Regarding the constituents (A), (B), (B1), (B2) and—if present—(C), as well as the design of the fibre-reinforced composite (K) and the process for producing the same, the previous definitions and preferred embodiments generally apply.

The molded body (M) having a carbon-fibre look is prepared from a fibre-reinforced composite (K) comprising glass fibres and/or carbon fibres as at least one continuous reinforcement material (A), preferably comprising at least one continuous reinforcement material (A) substantially consisting of carbon fibres. In particular, the at least outermost continuous reinforcement material (A), i.e. the continuous reinforcement material (A) which is intended to be visible in the molded body (M) having a carbon-fibre look, is substantially composed of carbon fibres. Preferably, said continuous reinforcement material (A) is at least one selected from a non-crimp fabric or a woven fabric. The non-crimp fabric or woven fabric may be selected with respect to the desired optical appearance. In one embodiment of the invention, said continuous reinforcement material (A) is a woven fabric, in particular selected from a twill weave. The at least one continuous fibrous reinforcement material (A) constitutes 35 to 55 vol.-%, preferably 40 to 50 vol.-% and in particular 45 to 47 vol.-%, of the entire molded body (M) having a carbon-fibre look.

In a preferred aspect of this embodiment, the at least one substantially amorphous matrix polymer composition (B) has a melt volume-flow rate (MVR (220/10) according to ISO 1133) of 40 to 70 mL/10 min, more preferably 45 to 60 mL/10 min, and a mold shrinkage according to ISO 294-4 of less than 1.5%, preferably less than 1%, more preferably in the range of 0.1 to 0.9, in particular in the range of 0.2 to 0.8%. Furthermore, the viscosity number VN (determined in dimethylformamide (DMF) according to DIN 53726) of the at least one substantially amorphous matrix polymer composition (B) is preferably within the range of 45 to 75 ml/g, preferably 55 to 70 ml/g, in particular 60 to 70 ml/g.

The combination of these specific components (A) and (B) allows the processing of the fibre-reinforced composite (K) to a molded body (M) having carbon-fibre look in a substantially reduced cycle time of 0.1 to 10 minutes, preferably 0.2 to 7 minutes, more preferred 0.3 to 5 minutes, and in particular 0.5 to 3 minutes, wherein the cycle time defines the time required in the molding device to produce one molded body (M), i.e. the time required for carrying out the process steps including at least process steps (iii) and (iv), preferably including at least process steps (ii), (iii) and (iv).

Preferably, the molded body (M) having carbon-fibre look is prepared using the above described variotherm process. This allows a further improvement of the surface quality, thus improving the carbon-fibre look. In a particular preferred embodiment of the invention, the molded body (M) having a carbon-fibre look is obtained, wherein the wherein the surface of the molded body (M) possesses a waviness characterized by Δw defined as the average altitude difference between a wave trough and a wave peak of less than 10 μm, preferably less than 8 μm. This allows the production of high quality surfaces which do not require further surface treatments such as polishing or coating with a clear coat. Thus, no post-processing is required.

The process for producing a molded body (M) or a molded body (M) having carbon-fibre look from a fibre-reinforced composite (K), may be carried out as a single process. Thus, the finished fibre-reinforced composite (K) is provided in step (i) of the process above. However, in an alternative embodiment, the thermoforming of the molded body (M) is carried out directly following the process for the preparation of the fibre-reinforced composite (K). In particular, in this aspect of the invention the thermoforming of the molded body (M) is carried out before the fibre-reinforced composite (K) reaches a temperature ≤Tg of the at least one substantially amorphous matrix polymer composition (B). Preferably, the thermoforming of the molded body (M) is carried out after step (e) of the process for preparing the fibre-reinforced composite (K) described above, and before step (f) of the process for preparing the fibre-reinforced composite (K) is carried out. This results in further reduction of cycle time and a reduction of energy required from heating.

The molded body (M) or a molded body (M) having carbon-fibre look may further be processed by injection molding or pressing of functional elements. A further cost advantage can thus be generated, since further mounting steps such as welding of functional elements can be dispensed.

The molded body (M) or a molded body (M) having carbon-fibre look may further be supported by applying reinforcement structures to at least a part of the molded body (M) or a molded body (M) having carbon-fibre look to improve the mechanical performance, in particular stiffness. In particular, ribbing structures may be applied to at least one surface of the molded body (M) or a molded body (M) having carbon-fibre look. In general, the optimal rib dimensioning includes production-technical, aesthetic and constructive aspects. Ribbing structures may, in particular be formed by back-injection molding processes after the formation of the molded body (M) or a molded body (M) having carbon-fibre look. In an alternative embodiment, the mechanical performance of the molded body (M) or a molded body (M) having carbon-fibre look is improved by an over-molding.

The invention also relates to a molded body (M) or a molded body (M) having carbon-fibre look obtained by a thermoforming process as described herein.

### Applications

The areas of application of the fibre-reinforced composite (K) and/or the molded body (M) are diverse. The fibre-reinforced composite (K) and/or the molded body (M) may be used as an element for structural and/or aesthetic applications. The fibre-reinforced composite (K) and/or the molded body (M) can thus be used in fields where materials are desired which are able to absorb relatively high forces under load before it comes to a total failure case, provide high strength and rigidity, at the same low density and other advantageous properties such as good aging and corrosion resistance.

Due to the exceptionally smooth surface achievable with the fibre-reinforced composite (K) and/or the molded body (M), in particular applications wherein the fibre-reinforced composite (K) and/or the molded body (M) is a visible part are possible, such as applications in automotive interior and/or exterior.

Moreover, due to the high smoothness of the surface combined with a high translucence of the matrix material (B), the fibre-reinforced composite (K) and/or the molded body (M) is in particular suited for applications wherein molded bodies (M) having carbon-fibre look are desired, i.e. applications, in which the structure of the continuous reinforcement material (A), in particular comprising carbon fibres, is visible from the exterior.

In one further aspect of the invention, the fibre-reinforced composite (K) and/or the molded body (M) may preferably be further processed by applying coatings to the surface, in particular for decoration purposes.

Without being limited, possible applications are for example in the areas of automotive (e.g. seat structures, front end modules, door carriers, firewalls, center consoles, body panels, interior trims, parts with carbon fibre look), healthcare (e.g. shoe inserts, prostheses, orthosis), sports and leisure (e.g. ski helmets, bicycle parts, ski, snowboards, drones, scale modeling), and electronics (e.g. back covers for tablets, notebooks, mobile phones and other mobile devices)

The invention is further illustrated by the following figures, examples and claims.

### FIGURES

FIG. 1a shows a photograph of a fracture surface obtained in a fatigue test made with a composite material comprising a polyamide matrix.

FIG. 1b shows an enlarged section from the photograph of FIG. 1a.

FIG. 2a shows a photograph of a fracture surface obtained in a fatigue test made with a composite material according to the invention.

FIG. 2b shows an enlarged section from the photograph of FIG. 2a.

FIG. 3a shows a molded body prepared in accordance with the invention at a mold surface temperature of 160° C.

FIG. 3b shows a molded body prepared in accordance with the invention at a mold surface temperature of 190° C.

FIG. 4a shows a molded body prepared from a composite material comprising a polyamide matrix at a mold surface temperature of 160° C.

FIG. 4b shows a molded body prepared from a composite material comprising a polyamide matrix at a mold surface temperature of 190° C.

FIG. 5a shows a molded body prepared with a mold surface temperature of a mold surface temperature of 80° C.

FIG. 5b shows a molded body prepared in accordance with the invention at a mold surface temperature of 160° C.

FIG. 5c shows a molded body prepared in accordance with the invention at a mold surface temperature of 190° C.

### EXAMPLES

### General Procedures

Weight average molecular weight and number average molecular weight are measured via gel permeation chromatography on standard columns with monodisperse polystyrene calibration standards.

Melt volume-flow rates (MVR (220/10) are determined according to ISO 1133.

Viscosity numbers (VN) are generally determined according to DIN 53726 at 25° C., using a solution of 0.5% by weight polymer in dimethylformamide (DMF).

Vicat softening temperatures are generally determined as VST/B/50 according to ISO 306.

Mold shrinkage is generally determined according to ISO 294-4.

Polymer density is generally determined according to ISO 1183.

### Mechanical Properties of the Fibre-Reinforced Composites

The following experiments were carried out on an intermittent hot press which is capable of producing a fibre/film composite of polymer film, melt or powder, for the quasi-continuous production of fibre-reinforced thermoplastic semi-finished products, laminates and sandwich panels.

### Technical Data for Melt Intermittent Hot Press are:

Board width: 660 mm
Laminate thickness: 0.2 to 9.0 mm
Laminate tolerances: max.±0.1 mm corresponding to semi-finished product
Sandwich plate thickness: max. 30 mm
Output: approx. 0.1-60 m/h, depending on quality and construction thickness
Nominal feed rate 5 m/h
Tool pressure: Pressing unit 5-25 bar, infinitely variable for minimum and maximum
tool size (optional)
Mold temperature control: 3 heating and 2 cooling zones
Tool temperature: up to 400° C.
Tool length: 1000 mm
Opening press: 0.5 to 200 mm
Preferred production direction: right to the left

### Technical Data of the Melt Plastification:

Discontinuous melt application in the middle layer for the production of fibre-reinforced thermoplastics semi-finished products

Screw diameter: 35 mm
Max. Displacement: 192 cm³
Max. Screw speed: 350 rpm
Max. Discharge current: 108 cm³/s
Max. Discharge pressure: 2406 bar specific with:
Melt volume: 22 ccm
Isobar=pressure-controlled pressing process
Isochor=volume controlled pressing process
T [° C.]=temperature of the temperature zones*
(*The press has 3 heating zones and 2 cooling zones, in the production direction)
P [bar]=pressure per cycle: isochorous 20
S [mm]=travel limit Press thickness: 1.1 mm
Temperature profile: (i) 210° to 245° C., therefore approx. 220° C.
(ii) 300° to 325° C., therefore about 300° C.
(iii) 270° to 320° C., therefore about 280° to 320° C.
(iv) 160° to 180° C.
(v) 80° C.
   T [sec]=pressing time per cycle: 20-30 s
   Construction/lamination: 6-layer structure with melt middle layer; Manufacturing Process: direct melt

### Components

### Continuous Fibrous Reinforcement Material (A)

A1: glass fibre twill fabric 2/2 with area weight=approx. 290 g/m² (type: 011020800-1240, producer: Hexcel, obtained from Lange+Ritter).

A2: glass fibre twill fabric 2/2 with area weight=approx. 320 g/m² (type: EC14-320-350; producer: PD Glasseide GmbH Oschatz).

A3: glass fibre non-woven fabric with surface area weight=approx. 50 g/m² (type: Evalith S5030, producer: Johns Manville Europe).

### Matrix Polymer (B)

B1: Styrene/acrylonitrile (S/AN) copolymer having the composition 76% by weight of styrene (S) and 24% by weight of acrylonitrile (AN), Mw of 135,000 g/mol (measured by gel permeation chromatography on standard columns with monodisperse polystyrene calibration standards); MVR (220/10)) of 64 mL/10 min (determined according to ISO1133); viscosity number (determined in DMF according to DIN 53726) VN=64 g/ml.

B2: Styrene/acrylonitrile/maleic anhydride (S/AN/MSA) copolymer having the composition (wt.-%): 75/24/1; Concentration of functional groups: 1 wt.-% of MSA (98.1 g/mol) in 75 wt.-% of S (104.2 g/mol) and 25 wt.-% of AN (53.1 g/mol), Mw of 131.000 g/mol, Mn of 58.000-60.000 g/mol (measured by gel permeation chromatography on standard columns with monodisperse polystyrene calibration standards); MVR (220/10)) of 22 mL/10 min (determined according to ISO1133); viscosity number (determined in DMF according to DIN 53726) VN=80 g/ml.

B3: blend of B1 and B2 in a ratio B2:131=1:2, concentration of functional groups: 0.33% by weight of MSA, MVR (220/10)) of 50 mL/10 min (determined according to ISO1133); viscosity number (determined in DMF according to DIN 53726) VN=65 g/ml.

B4: Styrene/acrylonitrile/maleic anhydride (S/AN/MSA) copolymer having the composition (wt.-%): 73.9/24/2.1; Concentration of functional groups: 2.1 wt.-% of MSA (98.1 g/mol) in 73.9 wt.-% of S (104.2 g/mol) and 24 wt.-% of AN (53.1 g/mol), Mw of 116,000 g/mol, Mn of 50.000-64.000 g/mol (measured by gel permeation chromatography on standard columns with monodisperse polystyrene calibration standards); MVR (220/10)) of 22 mL/10 min (determined according to ISO1133); viscosity number (determined in DMF according to DIN 53726) VN=80 g/ml.

PC(OD): easy-flowing, amorphous polycarbonate (optical grade for optical discs).

PA6: semi-crystalline, easy-flowing polyamide Durethan B30S.

The following fibre-reinforced composites were produced in order to investigate the E-modulus and the flexural strength, into which respective flat fibre material was introduced. The fibre composite materials produced each had a thickness of about 1.1 mm. For the preparation of the black samples, 2% by weight of carbon black was added to the polymer matrix.

TABLE 1
Design of the studied fibre-reinforced composites.

| | | Amount | | MSA in | | Fibre | |
|---|---|---|---|---|---|---|---|
| Example | | of glass | | matrix | Thickness | content | |
| No. | Fabric Layup | [g/m²] | Matrix | [wt.-%] | [mm] | [Vol.-%] | Color |
| 1 | A3/4 × A1/A3 | 1260 | B3 | 0.33 | 1.09 | 45.33 | black |
| V1 | A3/4 × A1/A3 | 1260 | B2 | 1.00 | 1.06 | 46.41 | black |
| V2 | A3/4 × A1/A3 | 1260 | B2 | 1.00 | 1.09 | 45.22 | transparent |
| V3 | A3/4 × A2/A3 | 1380 | PC(OD) | — | 1.14 | 44.56 | transparent |
| V4 | A3/4 × A2/A3 | 1380 | PA6 | — | 1.11 | 45.68 | black |

For the samples described in Table 1, the following mechanical properties were determined according to DIN EN ISO 14125.

TABLE 2
Mechanical properties of the studied fibre-
reinforced composites according Table 1.

| | | Flexural |
|---|---|---|
| | E-Modulus | strength |
| Example No. | [GPa] | [MPa] |
| 1 | 19.76 | 628.81 |
| V1 | 21.96 | 675.92 |
| V2 | 19.81 | 677.91 |
| V3 | 23.36 | 377.97 |
| V4 | 16.95 | 471.97 |

In summary, the fibre-reinforced composites according to the invention, in which the matrix polymer is formed from a blend of an S/AN copolymer and an S/AN/MSA copolymer, exhibit particularly high flexural strength and E-modulus compared to conventional fibre-reinforced composites having polycarbonate or polyamide matrices. Compared to polymer matrices comprising pure S/AN/MSA, the fibre composite materials according to the invention, are characterized by having a high melt-volume flow rate and a low viscosity number without having deteriorative effects on the mechanical properties. This combination was not achievable by pure S/AN/MSA copolymers. Example 1 and Comparative Examples V1 and V2 exhibit similar mechanical properties. However, the MVR (50 mL/10 min for Example 1 and 22 mL/10 min for Comparative Examples V1 and V2) as well as the viscosity numbers VN (65 g/mL for Example 1 and 80 g/mL Comparative Examples V1 and V2) attest to the better processability of the fibre-reinforced composites according to the invention.

In addition, the impact resistance or the penetration behavior (Dart test according to ISO 6603) was determined for the fibre-reinforced composite materials having the composite designs given in Table 3.

TABLE 3
Composite design of the studied fibre-reinforced
composites for the dart test.

| | | Amount of | | MSA in | |
|---|---|---|---|---|---|
| | | glass | | matrix | Thickness |
| Example No. | Fabric Layup | [g/m²] | Matrix | [wt.-%] | [mm] |
| 2 | A3/4 × A2/A3 | 1380 | B3 | 0.33 | 1.20 |
| V5 | A3/4 × A2/A3 | 1380 | B2 | 1.00 | 1.21 |
| V6 | A3/4 × A2/A3 | 1380 | B4 | 2.10 | 1.09 |
| 3 | A3/4 × A1/A3 | 1260 | B3 | 0.33 | 1.09 |
| V7 | A3/4 × A1/A3 | 1260 | B2 | 1.00 | 1.07 |
| V8 | A3/4 × A1/A3 | 1260 | B4 | 2.10 | 1.07 |
| V9 | A3/4 × A2/A3 | 1380 | PC(OD) | — | 1.2 |
| V10 | A3/4 × A2/A3 | 1380 | PA6 | — | 1.14 |

The measured experimental data are summarized in Table 4.

TABLE 4
Experimental data from the dart test according to ISO 6603.

| | Fm | Em | Ep |
|---|---|---|---|
| Example No. | [N] | [J] | [J] |
| 2 | 4725.13 | 9.56 | 14.47 |
| V5 | 4760.84 | 10.24 | 15.77 |
| V6 | 4649.99 | 9.29 | 14.29 |
| 3 | 3674.09 | 6.21 | 9.63 |
| V7 | 3512.75 | 6.12 | 8.95 |
| V8 | 3742.46 | 6.54 | 9.65 |
| V9 | 5428.50 | 13.26 | 18.73 |
| V10 | 3680.23 | 7.13 | 9.92 |

As can be seen from the above data, the fibre-reinforced composites according to the invention exhibit a high stability of Fm>3000 N which is comparable to known composite materials which have higher viscosities and are therefore more difficult to be processible and to obtain a sufficient impregnation.

Similar results were obtained for fibre-reinforced materials comprising fibrous reinforcement materials based on carbon fibres.

### Visual Evaluation

All of the fibre composite materials produced could be produced in the form of a (large) planar organo-sheet in a continuous process which could be cut to size without any problem (in laminable, transportable dimensions, such as 1 m×0.6 m). In the case of transparent fibre composite materials, the embedded fibre material was precisely recognizable when viewed in the backlight. In the case of the fibre composite materials with (black) colored matrix, the embedded fibre material was not recognizable even with closer optical observation in the backlight.

### Microscopic Evaluation

Defects (voids, incidence, etc.) were evaluated by means of reflected-light microscopy and surface quality by confocal laser scanning microscopy (LSM). A three-dimensional (3D) height survey (7.2 mm×7.2 mm) of the local measuring range and a two-dimensional (2D) representation of the height differences were calculated by means of LSM after scaling and application of different profile filters. Measurement errors and a general warpage/skew position of the sample were compensated by the use of profile filters (noise filter). The 2D elevation profile of the image was transferred via an integrated software lines into line profiles and evaluated computer-supported.

Fibre-reinforced composites each having a layup according to Example 1 as well as Comparative Examples V1, V3 and V4 described in Table 1 were tested. For each example, nine test specimens were evaluated. The mean wave depth (Wd) and the average roughness (Rg) were determined and summarized in Table 5.

TABLE 5
Results of the LSM measurements.

| Example | 1 | V1 | V3 | V4 |
|---|---|---|---|---|
| MW Wd [μm] | 4.573 | 4.827 | 11.745 | 12.323 |
| MW Rg [μm] | 3.583 | 4.019 | 6.406 | 4.968 |

The mean wave depth (Wd) observed in Example 1 had a value of 4.573 μm, thus being significantly lower than 10 μm and more than 5% smaller than the mean wave depth (Wd) observed in Comparative Example V1. Composite materials comprising PA6 and PD (OD) matrices typically have mean wave depth (Wd) of >10 μm. The determined average roughness (Rg) had a value of 3.583 μm for Example 1 and is also significantly lower for fibre-composite materials according to the invention, e.g. more than 10% smaller than average roughness (Rg) observed in comparative Example V1.

Similar results were obtained for fibre-reinforced materials comprising fibrous reinforcement materials based on carbon fibres.

### Tensile Tests and Compression Tests

Fibre-reinforced composites having a composite design similar to Example 1 were studied in Tensile Tests according to DIN EN ISO 527-4 in two directions (0° and 90°). The test sample had a thickness of about 2 mm and the testing speed was 2 mm/min.

Fibre-reinforced composites having a composite design similar to Example 1 were also studied in Compression Tests according to DIN EN ISO 14126 in two directions (0° and 90°). The test sample had a thickness of about 2 mm and the testing speed was 1 mm/min.

At least six samples were studied for each test and the mean values were calculated. The test results are summarized in Table 6.

TABLE 6
Experimental data form the Tensile Test and the Compression Test.

| | 0° direction | | 90° direction | |
|---|---|---|---|---|
| Testing | Strength | E-Modolus | Strength | E-Modolus |
| method | [MPa] | [GPa] | [MPa] | [GPa] |
| Tensile Test | 488.8 | 24.6 | 350.6 | 23.3 |
| (DIN EN ISO | | | | |
| 527-4) | | | | |
| Compression | 521.8 | 26.6 | 369.3 | 26.4 |
| Test | | | | |
| (DIN EN ISO | | | | |
| 14126) | | | | |

As can be seen from the above results, the E-modulus as well as the stability of the testing sample was higher in the compression tests than in the tensile test, i.e. the samples have a higher compressive strength than tensile strength in the 0° direction as well as in the 90° direction. This behavior is typically not observed for conventional fibre-reinforced thermoplastic composite materials. This specific property gives rise to improvements in applications wherein compression forces have to be compensated, e.g. in the protection against accidents.

### Evaluation of the Fracture Surface

Fibre-reinforced composites were studied in Fatigue Tests in a 4-point bending test according to DIN EN ISO 14125 until fracture occurred.

As test samples, two plates of glass fibre-reinforced SAN-composites having a strength of 2 mm were grouted to a plate of 3.85 mm.

As a comparative sample, fibre-reinforced composites comprising a PA6 matrix having a strength of 4.45 mm were studied.

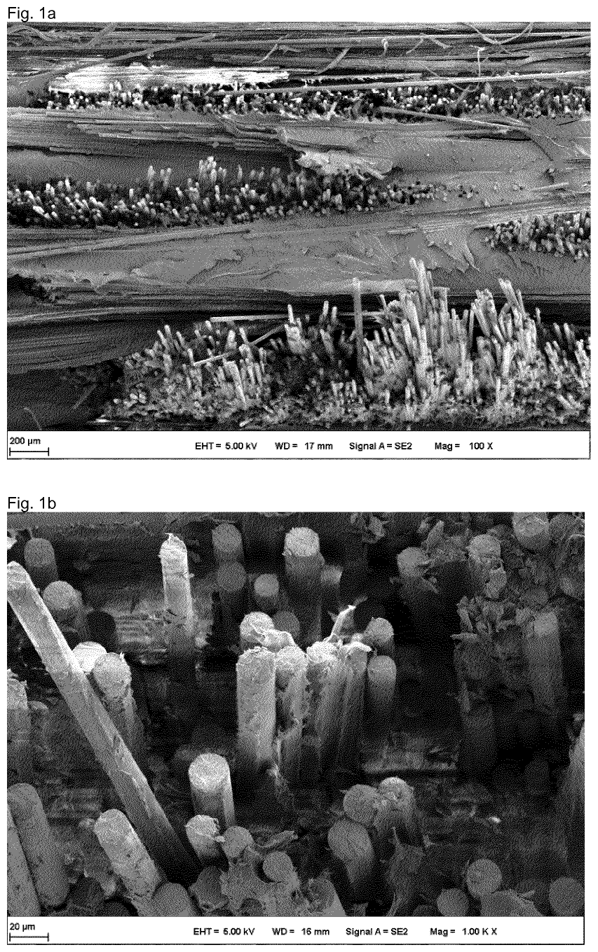

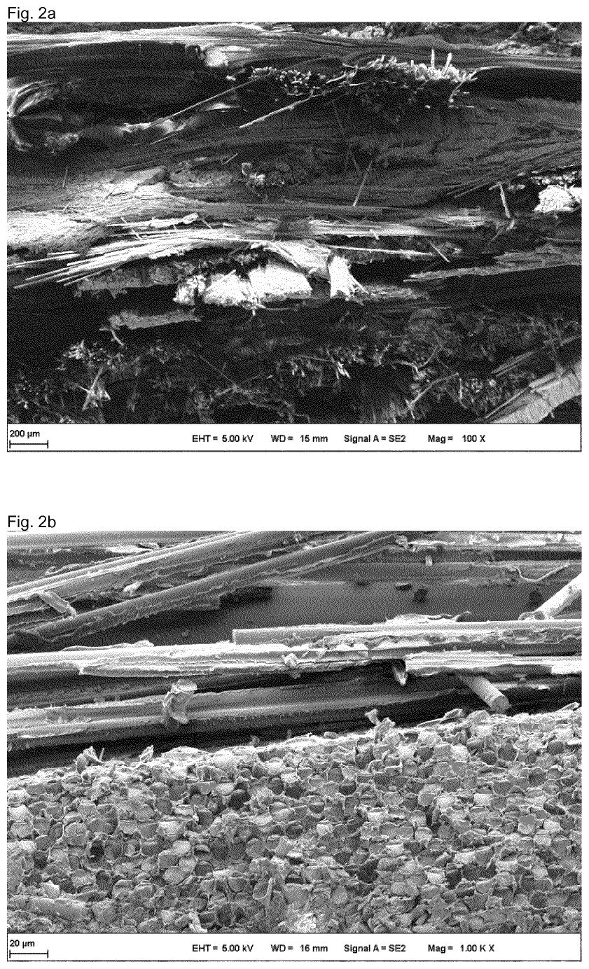

The fracture surfaces of the test samples were studied by microscopy and photographs were made. Photographs of the fracture surfaces are depicted in FIG. 1a, 1b and FIG. 2a, 2b, respectively.

The photographs were evaluated by visual methods.

As can be seen from FIG. 1a and FIG. 1b, the fracture surface of a sample comprising a polyamide matrix (PA6) exhibits numerous long reinforcement fibre endings, which protrude from the surface after fracture has occurred. This indicates an insufficient adhesion between the polymer matrix and the fibres within the fibre-reinforced material. It was determined by visual inspection of the photograph of FIG. 1b, that more than 10% of the reinforcement fibres protrude from the fracture surface with a length of at least 5 times the diameter of the respective fibre.

On the contrary, FIG. 2a and FIG. 2b reveal that the fibre-matrix adhesion is significantly higher in the fibre-reinforced composites (K) according to the present invention. As can be seen in the photographs, the reinforcement fibre endings at the fracture surface are short and protrude only very little from the surface. It was determined by visual inspection of the photograph of FIG. 2b, that less than 10% of the reinforcement fibres protrude from the fracture surface with a length of more than 5 times the diameter of the respective fibre.

Evaluation of the molding properties of the fibre-reinforced composites

The preparation of molded bodies (M) from fibre-reinforced composites having a composite design similar to Example 1 were studied.

The deformation properties at temperatures of 125° C., 150° C. and 175° C. were evaluated in a study determining the bending deformation under gravity. A sample (size: approximately 151 mm×50 mm×1 mm) was mounted only on one side. The sample was subjected to the temperatures specified in Table 7 and the deformation was determined by comparing the deformation prior to the test (traverse 0) and after 10 min (traverse 1). Three samples were tested for each temperature. The values given in Table 7 are averaged.

TABLE 7
Deformation property evaluation at different temperatures.

| Example | Temperature | Traverse 0 | Traverse 1 | |
|---|---|---|---|---|
| 4 | 125° C. | 1.2 mm | 1.2 | mm |
| 5 | 150° C. | 1.2 mm | 12.5 | mm |
| 6 | 175° C. | 1.2 mm | 105.5 | mm |

As can be seen from the above data, no deformation occurs at a temperature of 125° C. Thus, this temperature is not sufficient in a process for the preparation of a molded body without application of pressure. On the contrary, sufficient deformation is observed at 150° C. and 175° C.

More importantly, no decomposition, degassing and/or dripping of the matrix material was observed. The characteristics were highly reproducible.

### Preparation of Molded Bodies (M)

Molded bodies (M) were prepared from different fibre-reinforced composite materials using a forming press with IR emitter field having the following set-up:

Discontinuous conversion of fibre-reinforced thermoplastic semi-finished products

Pressing force: 20 to min./max. Pressure: 5/200 N/cm2
Working area: 350×300 mm
Max. Press stroke: 300 mm
Close speed: 70 mm/s
Pressing speed: 8 mm/s
Opening speed: 130 mm/s
Temperature heating plates: 400° C.
Technical data of the forming tool:
Semi-finished dimensions: 190×156 mm
Laminate thickness: 1.0 mm
Laminate tolerances: max.±0.05 mm corresponding to the semi-finished product
Oil temperature: up to 300° C.

Sample of fibre-reinforced composites of the size 190 mm×156×mm× 1.1 mm having the following lay-up were used:

TABLE 8
Composite design of the fibre-reinforced composites
used for thermoforming studies.

| | | | MSA in | |
|---|---|---|---|---|
| | | | matrix | |
| Example No. | Fabric Layup | Matrix | [wt.-%] | Color |
| 7 | A3/4 × A1/A3 | B3 | 0.33% | transparent |
| 8 | A3/4 × A1/A3 | B3 | 0.33% | black |
| 9 | A3/4 × A2/A3 | B3 | 0.33% | transparent |
| 10 | A3/4 × A2/A3 | B3 | 0.33% | black |
| V11 | A3/4 × A1/A3 | B2 | 1 | transparent |
| V12 | A3/4 × A2/A3 | PA6 | — | black |

Molded bodies were prepared with the process parameter given in Table 9.

TABLE 9
Thermoforming process parameter.

| | SAN matrix (Ex. 7 to 10, | | PA6 matrix (Comp. Ex. | |
|---|---|---|---|---|
| Parameter | Comp. Ex. V11) | | V12) | |
| Heating time | 45 s both sides | | 45 s both sides | |
| (IR heating) | | | | |
| Nominal | 240° | C. | 260° | C. |
| temperature of | | | | |
| the composite | | | | |
| material | | | | |
| Pressure | 200 | N/cm² | 200 | N/cm² |

| | | |
|---|---|---|
| Cooling time | 30 to 155 s (depending on | 30 to 155 s (depending on |
| | mold surface temperature) | mold surface temperature) |

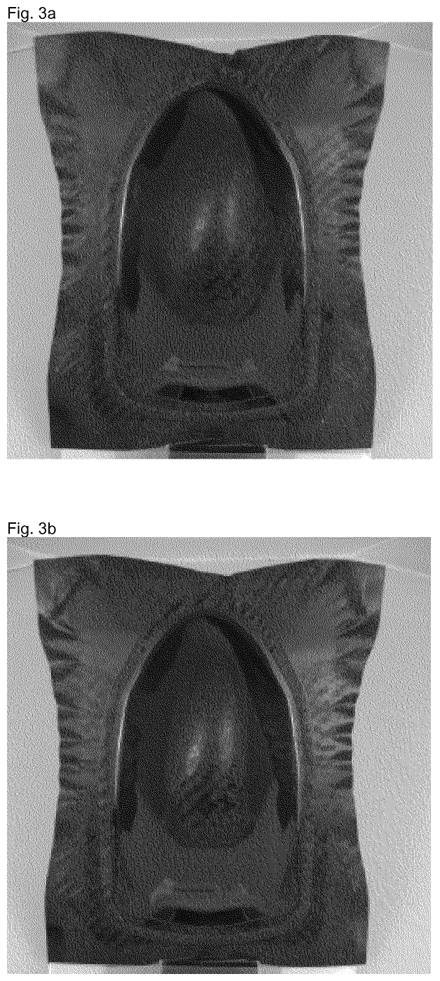

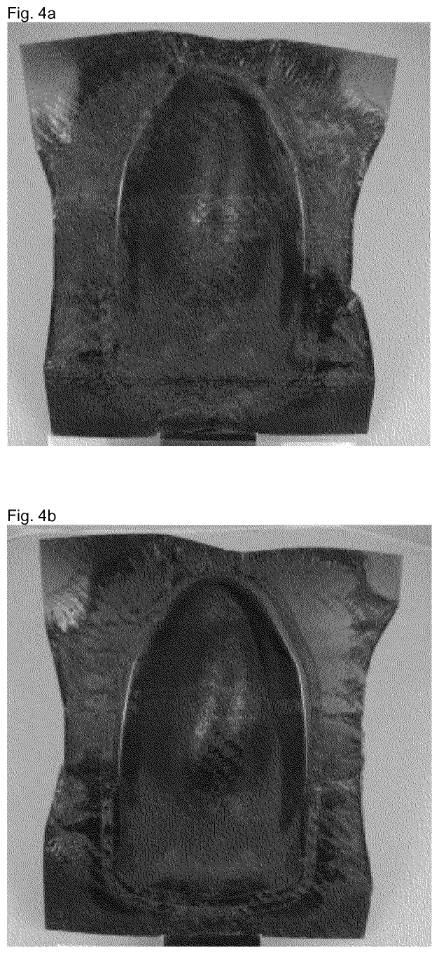

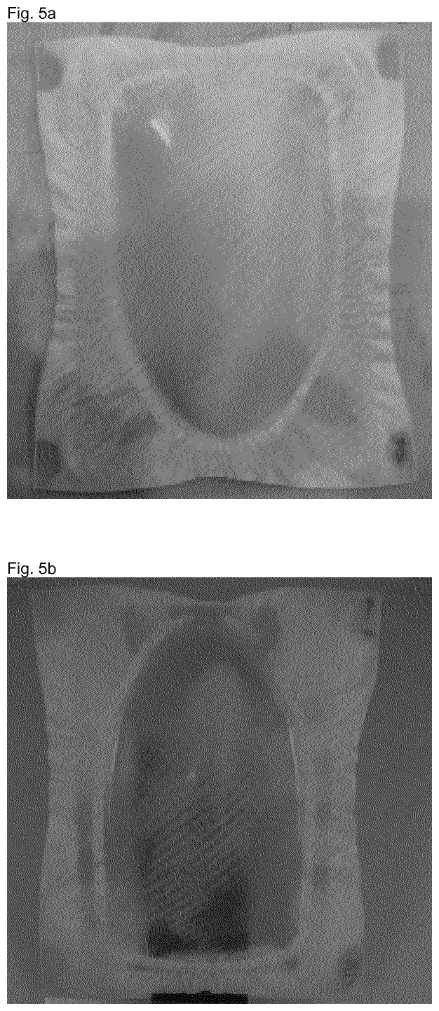

Molded bodies were prepared at mold surface temperatures of 160° C., 190° C. and 220° C. All molded bodies were processible. However, as can be seen from FIG. 3a and FIG. 3b, depicting molded bodies according to Example 10 prepared at 160° C. (FIG. 3a) and 190° C. (FIG. 3b), respectively, high quality molded bodies having smooth surfaces were obtained. By contrast, molded bodies prepared from Comparative Example V12 at 160° C. (FIG. 4a) and 190° C. (FIG. 4b), exhibit clearly inferior surface qualities. Thus, although the molded bodies according to the present invention were prepared at lower nominal temperatures of the composite material and thus in a process which demands less energy and less cycle time, the quality of the molded bodies is superior compared to conventional molded bodies having a polyamide matrix.

### Variotherm Process

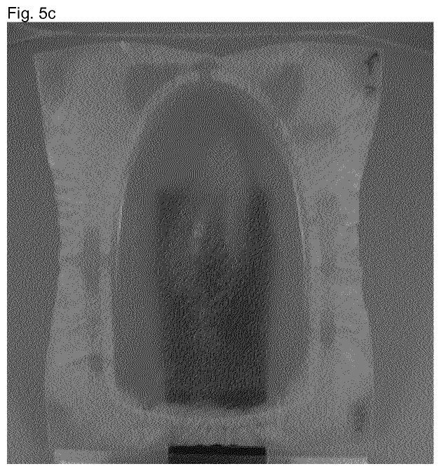

Molded bodies were prepared at in a variotherm process having a mold surface temperature of the thermoforming mold of 80° C., 160° C. and 190° C. As starting materials, the fibre-reinforced composites according to Example 1 and Comparative Example V8 were used. The composite of Comparative Example V8 was thermoformed with a surface temperature of the thermoforming device of 80° C. and a pressure of 200 N/cm². The obtained molded body is depicted in FIG. 5a. The composite according to Example 1 was thermoformed with a surface temperature of the thermoforming device of 160° C. and 190° C. a pressure of 200 N/cm², which is then cooled under pressure to a temperature of 80° C. The obtained molded body is depicted in FIG. 5b (prepared at 160° C.) and FIG. 5c (prepared at 190° C.). As can be seen from the photographs, the molded bodies obtained in the variotherm process exhibit high-quality surfaces. These may not be achieved in conventional processes. This effect may be attributed to the instant solidification of the surface of the heated fibre-reinforced composites if they are contacted with mold surfaces having a low temperature, e.g. a temperature as low as 80° C. The variotherm process allows thermoforming of the fibre-reinforced composite to a molded body (M) and thereafter cooling the surface of the molded body (M) under pressure in a controlled and fast manner without deterioration of the quality of the surface of the molded body. The cycle time is not significantly increased by the variotherm process and may further be improved by a variotherm process using an inductive heating device.

1-15. (canceled)

16. A process for preparing a fibre-reinforced composite (K) comprising at least the following steps:
(a) providing at least one continuous fibrous reinforcement material (A);
(b) providing at least one substantially amorphous matrix polymer composition (B) having melt volume-flow rate (MVR (220/10) according to ISO 1133) of 40 to 70 mL/10 min, and a viscosity number VN (according to DIN 53726) of 45 to 75 ml/g;
(c) applying the at least one substantially amorphous matrix polymer composition (B) to at least one surface of the at least one continuous fibrous reinforcement material (A) to obtain a layered arrangement;
(d) heating the layered arrangement obtained in step (c) to a first temperature (T1) sufficiently above the glass transition temperature (Tg) of the at least one substantially amorphous matrix polymer composition (B) to obtain a substantially liquid substantially amorphous matrix polymer composition (B);
(e) allowing the substantially liquid matrix polymer composition (B) to impregnate the at least one continuous fibrous reinforcement material (A); and
(f) cooling the thus obtained polymer-impregnated continuous fibrous reinforcement material (A) to a second temperature (T2) below the glass transition temperature (Tg) of the at least one substantially amorphous matrix polymer composition (B) in order to obtain a fibre-reinforced composite (K);
wherein substantially amorphous matrix polymer composition (B) is a thermoplastic styrene-based substantially amorphous matrix polymer composition (B) and wherein least one of the process steps (d) and/or (e) is carried out at a temperature in the range of 230 to 330° C.

17. The process for preparing a fibre-reinforced composite (K) according to claim 16 comprising at least the following steps:
(a) providing ≥50 wt.-%, based on the total weight of the fibre-reinforced composite (K), of at least one continuous fibrous reinforcement material (A);
(b) providing <50 wt.-%, based on the total weight of the fibre-reinforced composite (K), of at least one matrix polymer composition (B) comprising
(B1) 60 to 80 wt.-%, based on the total weight of the matrix polymer composition (B), of at least one copolymer of styrene and/or α-methyl styrene and acrylonitrile having a number average molecular weight Mn of 30,000 to 100,000 g/mol; and
(B2) 20 to 40 wt.-%, based on the total weight of the matrix polymer composition (B), of at least one copolymer of styrene, acrylonitrile, maleic anhydride, and/or maleic acid and optionally monomers comprising further chemical functional groups which are appropriate to interact with the surface of the at least one continuous fibrous reinforcement material (A) having a number average molecular weight Mn of 30,000 to 100,000 g/mol;
(c) applying the at least one matrix polymer composition (B) to at least one surface of the at least one continuous fibrous reinforcement material (A) to obtain a layered arrangement;
(d) heating the layered arrangement obtained in step (c) to a first temperature (T1) sufficiently above the glass transition temperature (Tg) of the at least one matrix polymer composition (B) to obtain a substantially liquid matrix polymer composition (B);
(e) allowing the substantially liquid matrix polymer composition (B) to impregnate the at least one continuous fibrous reinforcement material (A); and
(f) cooling the thus obtained polymer-impregnated continuous fibrous reinforcement material (A) to a second temperature (T2) below the glass transition temperature (Tg) of the at least one matrix polymer composition (B) in order to obtain a fibre-reinforced composite (K);
wherein the at least one matrix polymer composition (B) has a glass transition temperature (Tg) in the range of 100° C. to 150° C., a melt volume-flow rate (MVR (220/10) according to ISO 1133) of 40 to 70 mL/10 min, and a viscosity number VN (according to DIN 53726) of 45 to 75 ml/g.

18. The process for preparing a fibre-reinforced composite (K) according to claim 16, wherein the first temperature (T1) is in the range of 1 to 200° C., above glass transition temperature (Tg) of the at least one substantially amorphous matrix polymer composition (B) and the second temperature (T2) is in the range of 1 to 50° C. below the glass transition temperature (Tg) of the at least one substantially amorphous matrix polymer composition (B).

19. The process for preparing a fibre-reinforced composite (K) according to claim 16, wherein the first temperature (T1) is in the range of 180° C. to 300° C.

20. The process for preparing a fibre-reinforced composite (K) according to claim 16, wherein the second temperature (T2) is in the range of 70° C. to 100° C.

21. The process for preparing a fibre-reinforced composite (K) according to claim 16, wherein at least one of the process steps (d) to (f) is carried out under increased pressure.

22. The process for preparing a fibre-reinforced composite (K) according to claim 16, wherein at least the process step (f) is carried out under increased pressure, and the increased pressure is applied in step (f) until the second temperature (T2) is reached.

23. The process for preparing a fibre-reinforced composite (K) according to claim 16, wherein the at least one substantially amorphous matrix polymer composition (B) comprises >0 and 3 wt.-%, of repeating units derived from monomer moieties which are appropriate to interact with the surface of the fibrous reinforcement material (A).

24. The process for preparing a fibre-reinforced composite (K) according to claim 16, wherein the at least one continuous fibrous reinforcement material (A) is at least one laminar structure (S) selected from the group consisting of a non-crimp fabric, a woven fabric, a mat, a non-woven fabric, and a knitted fabric.

25. The process for preparing a fibre-reinforced composite (K) according to claim 16, wherein 1 to 12 laminar structures (S) are used as the at least one continuous fibrous reinforcement material (A).

26. The process for preparing a fibre-reinforced composite (K) according to claim 17, wherein 1 to 10 laminar structures (S) of a woven or non-crimped fabric and additionally at least one laminar structure (S) of a non-woven fabric are used as the at least one continuous fibrous reinforcement material (A), at least one laminar structure (S) of a non-woven fabric being positioned on the top and or bottom of the 1 to 10 laminar structures (S) of a woven or non-crimped fabric.

27. The process for preparing a fibre-reinforced composite (K) according to claim 26, wherein least one laminar structure (S) of a non-woven fabric comprises amorphous matrix polymer composition (B) in form of a powder or granules.

28. The process for preparing a fibre-reinforced composite (K) according to claim 16, wherein the at least one fibre reinforcement material (A) constitutes 35 to 55 vol.-% of the entire fibre-reinforced composite (K).

29. A fibre-reinforced composite (K) prepared by a process according to claim 16.

30. A molded body (M), optionally having carbon-fibre look, prepared by thermoforming a fibre-reinforced composite (K) according to claim 29.
